(19) United States
(12) Patent Application Publication
(10) Pub. No.: US 2021/0062957 A1
(43) Pub. Date: Mar. 4, 2021

(54) JOINT CONFIGURATIONS

(71) Applicant: CONCEPT GROUP LLC, Wellesley, MA (US)

(72) Inventors: Shriram RADHAKRISHNAN, West Palm Beach, FL (US); David H. REID, Jr., Fort Pierce, FL (US); Aarne H. REID, Jupiter, FL (US); Peter ROACH, Jacksonville, FL (US); William THOMAS, Landenberg, PA (US); George LEDOUX, Magnolia, NJ (US); Michael Cline MURRAY, Jupiter, FL (US)

(21) Appl. No.: 17/048,194

(22) PCT Filed: Apr. 17, 2019
(86) PCT No.: PCT/US2019/027918

§ 371 Date: Oct. 16, 2020

Related U.S. Application Data
(60) Provisional application No. 62/658,794, filed on Apr. 17, 2018.
(60) Provisional application No. 62/700,449, filed on Jul. 19, 2018.
(60) Provisional application No. 62/773,816, filed on Nov. 30, 2018.
(60) Provisional application No. 62/811,217, filed on Feb. 27, 2019.
(60) Provisional application No. 62/825,123, filed on Mar. 28, 2019.

(51) Int. Cl. F16L 59/065

(52) U.S. Cl. CPC F16L 59/065

(57) ABSTRACT

Provided are thermally insulating components that include sealed joints between the walls that define an insulating space therebetween. Also provided are related methods of forming and using the disclosed components.

### RELATED APPLICATIONS

The present application claims priority to and the benefit of U.S. patent applications 62/658,794 (filed Apr. 17, 2018); 62/700,449 (filed Jul. 19, 2018); 62/773,816 (filed Nov. 30, 2018); 62/811,217 (filed Feb. 27, 2019); and 62/825,123 (filed Mar. 28, 2019), all of which applications are incorporated herein by reference in their entireties for any and all purposes.

### TECHNICAL FIELD

The present disclosure relates to the field of forming sealed, evacuated spaces for use as thermal insulation.

### BACKGROUND

Thermally-insulating components are needed in a broad range of applications, e.g., fluid transport, fluid storage, and the like. Existing thermally-insulating components, however, can be difficult to assemble and may not always meet the user's needs in terms of their thermal insulation capabilities. In particular, the wall-to-wall joints used to assemble existing thermal insulation components can be difficult to manufacture and process. Accordingly, there is a long-felt need in the art for improved thermal insulation components, as well as related methods of using such components.

### SUMMARY

In meeting the long-felt needs described above, the present disclosure first provides a molecule excitation chamber, comprising: a first wall bounding an interior volume, the first wall comprising a main portion having a length and a projection portion having a length, the main portion optionally extending perpendicular to the projection portion; a second wall bounding the interior volume, the second wall comprising a main portion having a length and optionally comprising a projection portion having a length, (a) the projection portion of the first wall and the second wall defining a first vent therebetween, or (b) the second wall and the first wall defining a second vent therebetween, or (c) both (a) and (b), and the ratio of the length of the main portion of the first wall to the projection portion of the first wall being from about 1000:1 to about 1:1, and, optionally, a heat source configured to effect heating of molecules disposed within the interior volume of the molecule excitation chamber.

Also provided are methods, comprising opening the first vent of a molecule excitation chamber according to the present disclosure.

Further provided are methods, comprising: assembling (a) a first wall comprising a main portion having a length and a projection portion having a length, the main portion optionally extending perpendicular to the projection portion, and the ratio of the length of the main portion of the first wall to the projection portion of the first wall being from about 1000:1 to about 1; 1, and (b) a second wall comprising a main portion having a length and optionally comprising a projection portion having a length, the assembling being performed so as to define a first vent defined by the projection portion of the first wall and the second wall, and, sealing the first vent so as to seal a space between the first wall and the second wall.

Also disclosed are insulating components, comprising: a first wall bounding an interior volume; a second wall spaced at a distance from the first wall so as to define an insulating space between the first wall and the second wall; an inner surface of the second wall facing the insulating space, and an outer surface of the first wall facing the insulating space, (a) the first wall comprising an extension portion that (i) extends from a first end of the first wall toward the inner surface of the second wall and is optionally essentially perpendicular to the inner surface of the second wall and/or (ii) extends toward a second end of the first wall, the extension portion of the first wall optionally further comprising a land portion that is essentially parallel to the inner surface of the second wall, or (b) the second wall comprising an extension portion that (i) extends from a first end of the second wall toward the outer surface of the first wall and is optionally essentially perpendicular to the outer surface of the first wall and/or (ii) extends toward a second end of the second wall, the extension portion of the second wall optionally further comprising a land portion that is essentially parallel to the outer surface of the first wall, or both (a) and (b), and a first vent communicating with the insulating space to provide an exit pathway for gas molecules from the insulating space, the vent being sealable for sealing the insulating space following egress of gas molecules through the vent.

Additionally provided are methods, comprising communicating a fluid within the interior volume of an insulating component according to the present disclosure.

Also disclosed are methods, comprising heating a material disposed at least partially within the interior volume of an insulating component according to the present disclosure.

Further provided are methods, comprising: with a first wall bounding an interior volume and a second wall spaced at a distance from the first wall, a volume defined between the first wall and the second wall, (a) the first wall comprising an extension portion that extends toward the second wall and is optionally essentially perpendicular to the inner surface of the second wall, the extension portion of the first wall optionally further comprising a land portion that is essentially parallel to the inner surface of the second wall, (b) the second wall comprising an extension portion that extends toward the outer surface of the first wall and is optionally essentially perpendicular to the outer surface of the first wall, the extension portion of the second wall optionally further comprising a land portion that is essentially parallel to the outer surface of the first wall, or both (a) and (b), and (c) the land portion of the first wall contacting the second wall so as to define a volume between the first wall and the second wall, (d) the land portion of the second wall contacting the first wall so as to define a volume between the first wall and the second wall, or both (c) and (d), heating the first wall and the second wall under conditions effective to effect thermal expansion of the second wall relative to the first wall, the thermal expansion giving give rise to or increasing a space between the land portion of the first wall and the second wall and/or giving rise to or increasing a space between the land portion of the second wall and the first wall, thereby allowing gas molecules to exit the volume defined between the first wall and the second wall.

Additionally provided are insulating components, comprising: a first wall bounding an interior volume; a second wall spaced at a distance from the first wall so as to define an insulating space between the first wall and the second wall; a first cap, the first cap at least partially sealing the insulating space defined between the first wall and the second wall, the first cap comprising a first land, the first land optionally sealed to the first wall, and the first cap further comprising a second land, the second land optionally sealed to the second wall. a first vent communicating with the insulating space to provide an exit pathway for gas molecules from the insulating space, the first vent being sealable for sealing the insulating space following egress of gas molecules through the vent.

Further provided are insulating components, comprising: a first wall bounding an interior volume; a second wall spaced at a distance from the first wall so as to define an insulating space between the first wall and the second wall; a first cap defining a curved profile, the first cap at least partially sealing the insulating space defined between the first wall and the second wall, a second cap defining a curved profile, the second cap comprising a first portion sealed to the first wall, the second cap further comprising a second portion sealed to the second wall, and the curved profile of first wall and the curved profile of the second wall being concave away from one another.

The present disclosure also provides methods of testing a component. In these methods, a user may subject a component (e.g., a thermal insulator) to vibration and/or a strike. The user may then collect information (e.g., a sound) that is related to the subjection of the component to the vibration and/or strike, and perform further processing of the information.

Also provided are testing systems. A system according to the present disclosure can include a vibrator device and a component mount. The system can further include a component secured to the component mount, the component comprising an amount of ceramic, the component comprising a sealed evacuated region within the component, or both, the component being secured such that the component is in mechanical communication with the vibrator device, fluid communication with the vibrator device, or both.

The present disclosure also provides testing systems, comprising: a strike plate; and a transducer configured to receive energy evolved from the impact of a component onto the strike plate.

Further provided are methods of preparing an insulating component, comprising: forming a conditioned region of a surface of a first boundary component by conditioning at least a portion of the surface of the first boundary component; forming a conditioned region of a surface of a second boundary component by conditioning at least a portion of the surface of the second boundary component; and processing the first boundary component and the second boundary component under conditions sufficient to give rise to a sealed evacuated region between the first boundary component and the second boundary component, the sealed evacuated region being at least partially defined by the conditioned region of the surface of the first boundary component and the conditioned region of the surface of the second boundary component.

Also provided are methods of preparing an insulating component, comprising: conditioning (a) a facing surface of a first boundary component and (b) a facing surface of a second boundary component; and further processing the first boundary component and a second boundary component under conditions sufficient to give rise to a sealed evacuated region between the facing surface of the first boundary component and the facing surface of the second boundary component.

Further provided are insulated components made according to the disclosed methods.

Additionally provided are methods of constructing an insulating component, comprising: assembling a first boundary component and a second boundary component so as to form a sealed insulating space between a surface region of the first boundary component and a surface region of a second boundary component, the surface region of the first boundary component and the surface region of the second boundary component treated to remove impurities (e.g, moisture and/or other molecular species).

Further provided are insulated components, comprising: a first boundary component and a second boundary component disposed so as to form a sealed insulating space between a surface region of the first boundary component and a surface region of a second boundary component, the surface region of the first boundary component and the surface region of the second boundary component being treated to remove impurities.

Also provided are systems configured to effect a conditioned region on a workpiece, the system comprising: an enclosure configured to sealably enclose one or more workpieces within the interior of the enclosure; (a) a component configured to modulate at least one of (i) fluid flow into the interior of the enclosure, and (ii) fluid flow out of the interior of the enclosure; (b) an element configured to modulate a temperature within the interior of the enclosure; optionally (c) a heat source (that optionally comprises an element configured to direct radiation toward a workpiece disposed within the interior of the enclosure); (d) a fluid source capable of fluid communication with the interior of the enclosure, or any combination of (a), (b), (c), and (d).

Further provided are systems configured to perform the methods provided herein.

Additionally provided are methods, comprising: (a) changing a temperature and/or pressure so as to affect an interface between a first and a second boundary within which region is contained a first fluid; (b) removing at least some of the first fluid from the region; (c) introducing a second fluid into said region; and (d) containing the second fluid within the region.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides a cutaway view of an exemplary component according to the present disclosure, showing an illustrative wall configuration;

FIG. 2 provides a cutaway view of an exemplary component according to the present disclosure, showing an illustrative wall configuration;

FIG. 3 provides a cutaway view of an exemplary component according to the present disclosure, showing an illustrative wall configuration;

FIG. 4 provides a cutaway view of an exemplary component according to the present disclosure, showing an illustrative wall configuration;

FIG. 5 provides a cutaway view of an exemplary component according to the present disclosure, showing an illustrative wall configuration;

FIG. 6 provides a cutaway view of an exemplary component according to the present disclosure, showing an illustrative wall configuration;

FIG. 7 provides a cutaway view of an exemplary component according to the present disclosure, showing an illustrative wall configuration;

FIG. 8 provides a cutaway view of an exemplary component according to the present disclosure, showing an illustrative wall configuration;

FIG. 9 provides a cutaway view of an exemplary component according to the present disclosure, showing an illustrative wall configuration;

FIG. 10 provides a cutaway view of an exemplary component according to the present disclosure, showing an illustrative wall configuration;

FIG. 11 provides a cutaway view of an exemplary component according to the present disclosure, showing an illustrative wall configuration;

FIG. 12 provides a cutaway view of an exemplary component according to the present disclosure, showing an illustrative wall configuration;

FIG. 13 provides a cutaway view of an exemplary component according to the present disclosure, showing an illustrative wall configuration;

FIG. 14 provides a cutaway view of an exemplary component according to the present disclosure, showing an illustrative wall configuration;

FIG. 15A, FIG. 15B, and FIG. 15C provide cutaway views of an exemplary component according to the present disclosure, showing an illustrative wall configuration;

FIG. 16 provides a cutaway view of an exemplary component according to the present disclosure, showing an illustrative wall configuration;

FIG. 17 provides a cutaway view of an exemplary component according to the present disclosure, showing an illustrative wall configuration;

FIG. 18 provides a cutaway view of an exemplary component according to the present disclosure, showing an illustrative wall configuration;

FIG. 19 provides a cutaway view of an exemplary component according to the present disclosure, showing an illustrative wall configuration;

FIG. 20 provides a cutaway view of an exemplary component according to the present disclosure, showing an illustrative wall configuration;

FIG. 21 provides a cutaway view of an exemplary component according to the present disclosure, showing an illustrative wall configuration;

FIG. 22 provides a cutaway view of an exemplary component according to the present disclosure, showing an illustrative wall configuration;

FIG. 23 provides a cutaway view of an exemplary component according to the present disclosure, showing an illustrative wall configuration;

FIG. 24 provides a cutaway view of an exemplary component according to the present disclosure, showing an illustrative wall configuration;

FIG. 25 provides a cutaway view of an exemplary component according to the present disclosure, showing an illustrative wall configuration;

FIG. 26 provides a cutaway view of an exemplary component according to the present disclosure, showing an illustrative wall configuration;

FIG. 27 provides a cutaway view of an exemplary component according to the present disclosure, showing an illustrative wall configuration;

FIG. 28 provides a close-up cutaway view of a joint region of an exemplary component according to the present disclosure;

FIG. 29 provides a cutaway view of an exemplary component according to the present disclosure, showing an illustrative wall configuration;

FIG. 30 provides a close-up cutaway view of a joint region of an exemplary component according to the present disclosure;

FIG. 31 provides a cutaway view of an exemplary component according to the present disclosure, showing an illustrative wall configuration;

FIG. 32 provides a cutaway view of an exemplary component according to the present disclosure, showing an illustrative wall configuration;

FIG. 33 provides a cross-sectional view of a joint region of an exemplary component according to the present disclosure;

FIG. 34 provides a close-up view of the ends of a ring of braze material in a component according to the present disclosure;

FIG. 35 provides a cutaway view of two tube sections joined according to the present disclosure;

FIG. 36 provides a cutaway view of an exemplary component according to the present disclosure, showing an illustrative wall configuration;

FIG. 37 provides a cutaway view of an exemplary component according to the present disclosure, showing an illustrative wall configuration;

FIG. 38 provides a cutaway view of an exemplary component according to the present disclosure, showing an illustrative wall configuration;

FIG. 39 provides a cutaway view of an exemplary component according to the present disclosure, showing an illustrative wall configuration;

FIG. 40 provides a cutaway view of an exemplary component according to the present disclosure, showing an illustrative wall configuration;

FIG. 41 provides a cutaway view of an exemplary component according to the present disclosure, showing an illustrative wall configuration;

FIG. 42 provides a cutaway view of an exemplary component according to the present disclosure, showing an illustrative wall configuration;

FIG. 43 provides a cutaway view of an exemplary component according to the present disclosure, showing an illustrative wall configuration;

FIG. 44 provides a cutaway view of an exemplary component according to the present disclosure, showing an illustrative wall configuration;

FIG. 45 provides a cutaway view of an exemplary component according to the present disclosure, showing an illustrative wall configuration;

FIG. 46 provides a cutaway view of an exemplary component according to the present disclosure, showing an illustrative wall configuration;

FIG. 47 provides a view of an exemplary cap according to the present disclosure; and

FIG. 48 provides a cutaway view of the cap shown in FIG. 47;

FIG. 49 provides a cutaway view of an exemplary article according to the present disclosure;

FIG. 50 provides a cutaway view of an exemplary article according to the present disclosure;

FIG. 51 provides a cutaway view of an exemplary article according to the present disclosure; and

FIG. 52 provides a cutaway view of an exemplary article according to the present disclosure.

FIG. 53 provides an exemplary process flow according to the present disclosure.

FIG. 54 provides a cutaway view of a system according to the present disclosure;

FIG. 55A and FIG. 55B provide cutaway views of an article according to the present disclosure; and

FIG. 56 provides a flowchart of an exemplary process according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

Exemplary walls, sealing processes, and insulating spaces can be found in, e.g., US2018/0106414; US2017/0253416; US2017/0225276; US2017/0120362; US2017/0062774; US2017/0043938; US2016/0084425; US2015/0260332; US2015/0110548; US2014/0090737; US2012/0090817; US2011/0264084; US2008/0121642; US2005/0211711; WO/2019/014463; WO/2019/010385; WO/2018/093781; WO/2018/093773; WO/2018/093776; PCT/US2018/047974; WO/2017/152045; U.S. 62/773,816; and U.S. Pat. No. 6,139,571, the entireties of which documents are incorporated herein for any and all purposes.

### FIGURES

The attached non-limiting figures illustrate various aspects of the disclosed technology. It should be understood that these figures are exemplary only and do not limit the scope of the present disclosure or the appended claims.

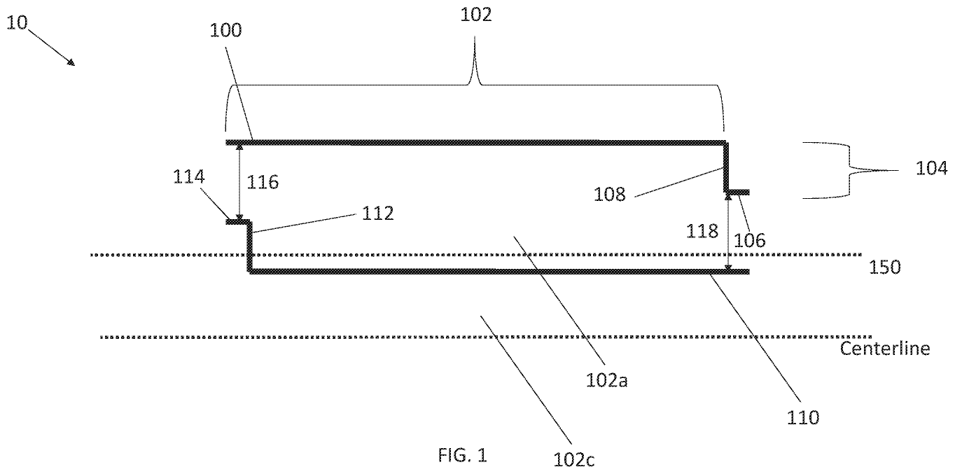

FIG. 1 provides an exemplary depiction of a component 10 according to the present disclosure. As shown, component 10 includes first wall 100, which first wall can define a main portion 102. The first wall can include a projection portion 108, which can optionally project perpendicular from the main portion, though this is not a requirement. Projection portion can define a length 104. The first wall can also include a land portion 106.

As shown, vent 118 can be defined between first wall 100 and second wall 110. Second wall 110 can include a main portion (not labeled); second wall 110 can also define a volume therein, e.g., when second wall 110 is tubular in configuration. Second wall 110 can also include projection portion 112, which can optionally project perpendicular from second wall 110. Second wall 110 can also include land portion 114. Second vent 116 can be defined between the first wall and the second wall. As shown, a line 150 that is parallel to the major axis of the space defined between first wall 100 and second wall 110 can be drawn. In some embodiments, such a parallel line does not intersect both first vent 116 and second vent 118. Wall 100 and wall 110 can define a space/volume 102a therebetween. (It should be understood that the terms “first wall” and “second wall” are for convenience only and are not limiting. As one example, the “first wall” can be the inner wall of a double-wall tube component or the outer wall of that double-wall tube component.)

It should be understood that one or both of walls 100 and 110 can be cylindrical in configuration. In this way, the walls can define a volume (102c) within wall 110, which volume 102c can be cylindrical in shape and can have a centerline (shown in FIG. 1). It should also be understood that either or both of walls 100 and 110 can include one or more fins extending therefrom. A fin can act as a heat sink and/or as a heat exchange surface.

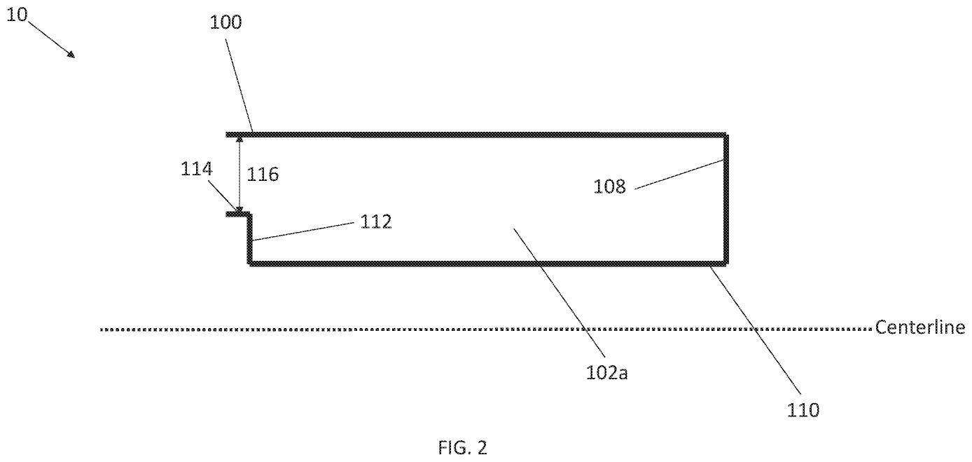

FIG. 2 provides a depiction of an alternative embodiment of a component according to the present disclosure. As shown, first wall 100 includes a projection portion 108, which can optionally project perpendicular from the main portion, though this is not a requirement. Second wall 110 can include a main portion (not labeled). Second wall 110 can also include projection portion 112, which can optionally project perpendicular from second wall 110. Second wall 110 can also include land portion 114. Second vent 116 can be defined between the first wall and the second wall. As shown, the embodiment of FIG. 2 includes only a single vent, i.e., vent 114. Wall 100 and wall 110 can define a space/volume 102a therebetween, which can be evacuated.

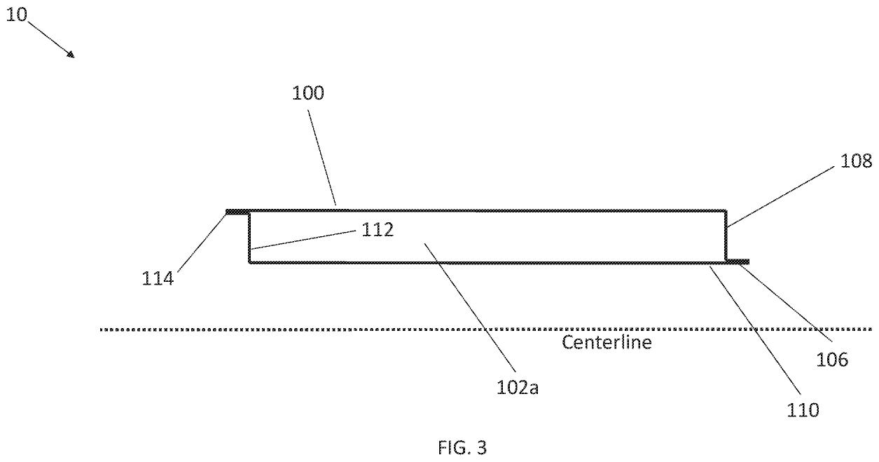

FIG. 3 provides a further depiction of an embodiment of the disclosed technology, in this case a sealed version of FIG. 1. More specifically, the depicted component includes a first wall 100. The first wall can include a projection portion 108, which can optionally project perpendicular from the main portion, though this is not a requirement. The first wall can also include a land portion 106, which land portion can be sealed to second wall 110. Second wall 110 can also include projection portion 112, which can optionally project perpendicular from second wall 110. Second wall 110 can also include land portion 114, which can be sealed to first wall 100. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

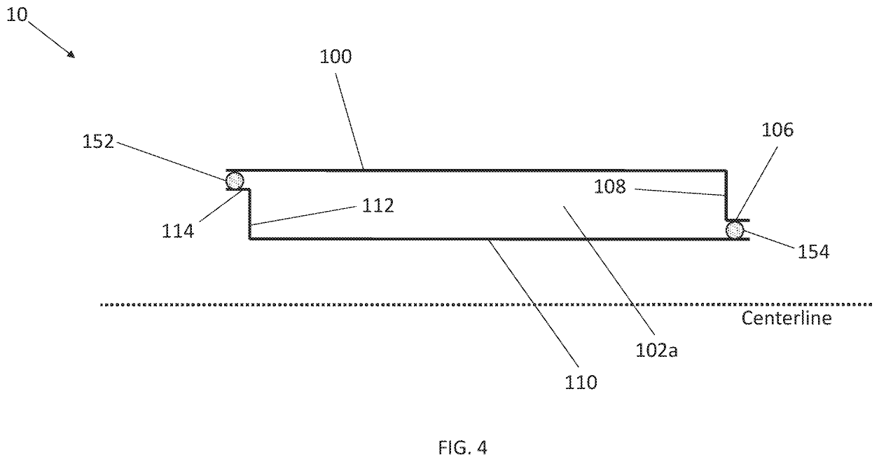

FIG. 4 provides a further depiction of an embodiment of the disclosed technology, in this case a sealed version of FIG. 1. More specifically, the depicted component includes a first wall 100. The first wall can include a projection portion 108, which can optionally project perpendicular from the main portion, though this is not a requirement. The first wall can also include a land portion 106, which land portion can be sealed to second wall 110 by way of sealant 154. Second wall 110 can also include projection portion 112, which can optionally project perpendicular from second wall 110. Second wall 110 can also include land portion 114, which can be sealed to first wall 100 by way of sealant 152. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

Although the attached figures show in some cases that the spaces/vents between walls are open, it should be understood that any and all of these vents can be sealed.

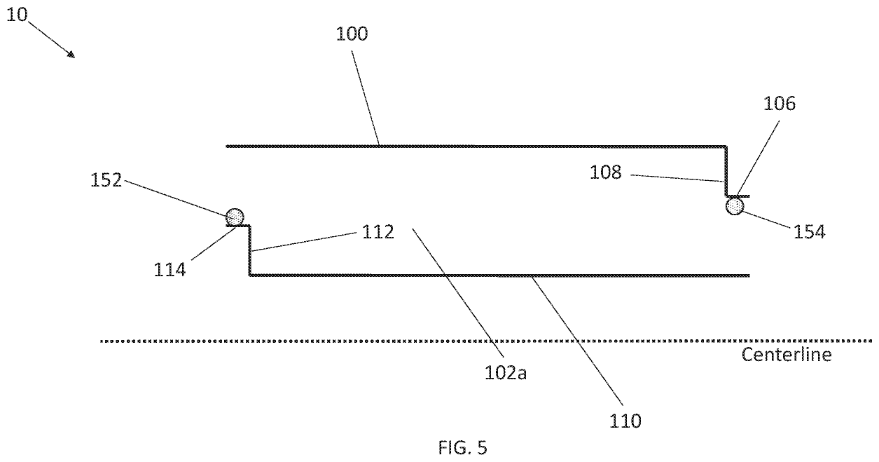

FIG. 5 provides a further depiction of an embodiment of the disclosed technology, in this case a version of the component of FIG. 5 that is not fully assembled. More specifically, the depicted component includes a first wall 100. The first wall can include a projection portion 108, which can optionally project perpendicular from the main portion, though this is not a requirement. The first wall can also include a land portion 106, which land portion can be sealed to second wall 110 by way of sealant 154. Second wall 110 can also include projection portion 112, which can optionally project perpendicular from second wall 110. Second wall 110 can also include land portion 114, which can be sealed to first wall 100 by way of sealant 152. A parallel to the major axis of the space defined between first wall 100 and second wall 110 can be drawn. In some embodiments, such a parallel line does not intersect the seals between the first wall and the second wall at lands 106 and 114. Wall 100 and wall 110 can define a space/volume 102a therebetween.

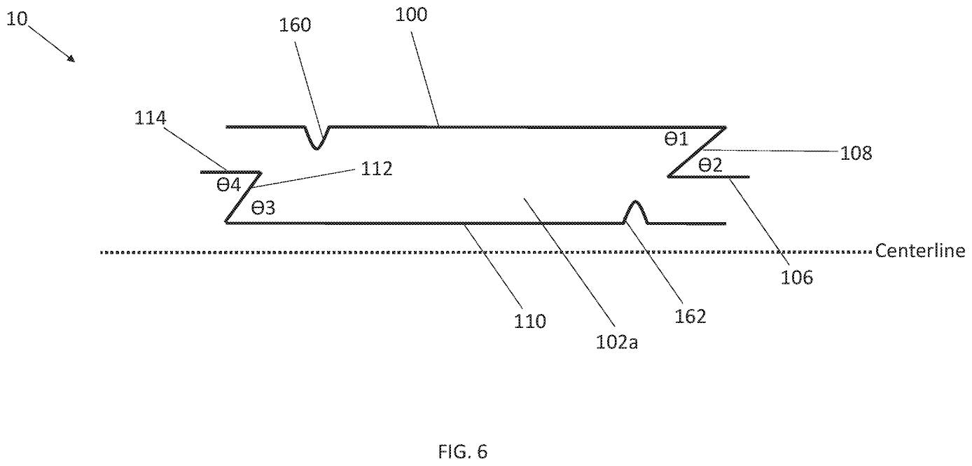

FIG. 6 provides a further depiction of an embodiment of the disclosed technology. As shown, the depicted component includes a first wall 100. The first wall can include a projection portion 108, which can project at an angle θ1 from first wall 100. The angle θ1 can be from about 90 degrees to about 1 degree, i.e., with projection portion 108 angled back over wall 100. Land 106 can extend from projection portion 108, as shown. Land 106 can be at an angle θ2 from projection portion 108, which angle can be from about 1 to about 180 degrees, including all intermediate values and ranges of values. As shown, land 106 and wall 110 can define an opening or vent therebetween. Wall 100 can include feature 160, which feature can be, e.g., a ridge, a bump, a ring, and the like.

Without being bound by any particular theory, such a feature can act to impede the movement of molecules within the space defined between wall 100 and wall 110. Wall 110 can include a feature 162, which feature can be, e.g., a ridge, a bump, a ring, and the like. Without being bound by any particular theory, such a feature can act to impede the movement of molecules within the space defined between wall 100 and wall 110. Wall 110 can include a projection portion 112, which can project at an angle θ3 from second wall 110. Angle θ3 can be from about 90 degrees to about 1 degree, i.e. with projection portion 112 angled back over second wall 110. Second wall 110 can also include land 106. Land 106 can project at an angle θ4 from projection portion 112, which angle can be from about 1 to about 180 degrees, including all intermediate values and ranges of values. As shown, wall 100 and land 114 can define an opening (or vent) therebetween. Wall 100 and wall 110 can define a space/volume 102a therebetween.

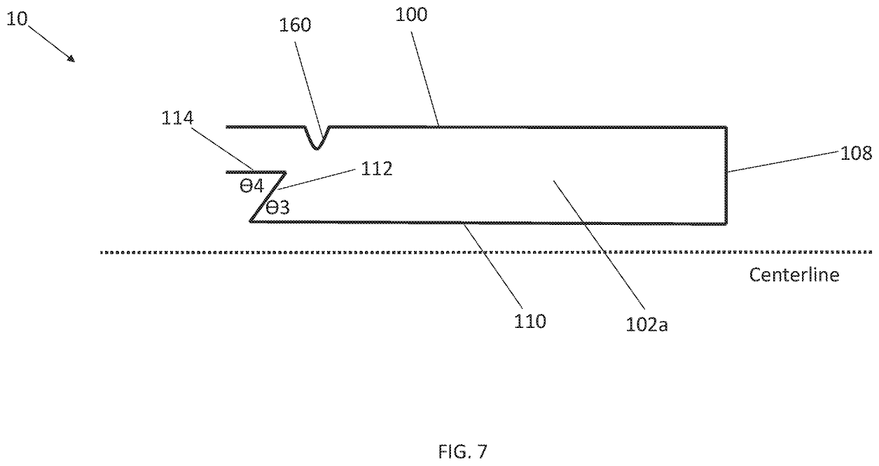

FIG. 7 provides a further depiction of an embodiment of the disclosed technology. As shown, the depicted component includes a first wall 100. The first wall can include a projection portion 108. Wall 100 can include feature 160, which feature can be, e.g., a ridge, a bump, a ring, and the like.

Without being bound by any particular theory, such a feature can act to impede the movement of molecules within the space defined between wall 100 and wall 110. Wall 110 can include a feature 162, which feature can be, e.g., a ridge, a bump, a ring, and the like.

Without being bound by any particular theory, such a feature can act to impede the movement of molecules within the space defined between wall 100 and wall 110. Wall 110 can include a projection portion 112, which can project at an angle θ3 from second wall 110. Angle θ3 can be from about 90 degrees to about 1 degree, i.e. with projection portion 112 angled back over second wall 110. Second wall 110 can also include land 106. Land 106 can project at an angle θ4 from projection portion 112, which angle can be from about 1 to about 180 degrees, including all intermediate values and ranges of values. Wall 100 and wall 110 can define a space/volume 102a therebetween.

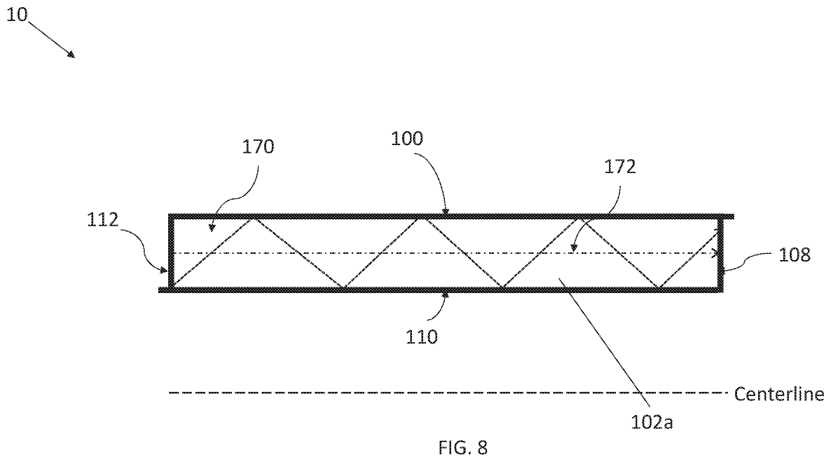

FIG. 8 provides a further depiction of an embodiment of the disclosed technology. As shown, the depicted component includes a first wall 100. The first wall can include a projection portion 108. Wall 110 can include a projection portion 112. As shown, path 170 shows the zig-zag path that is taken by a molecule that impacts first wall 100 and second wall 110, with centerline 172 being used to show the path of a molecule that travels roughly along the centerline of the component. Wall 100 and wall 110 can define a space/volume 102a therebetween.

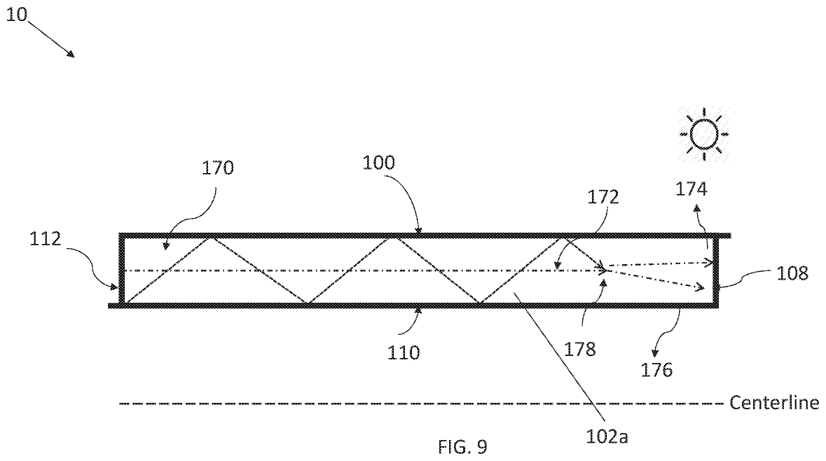

FIG. 9 provides a further depiction of an embodiment of the disclosed technology. As shown, the depicted component includes a first wall 100. The first wall can include a projection portion 108. Wall 110 can include a projection portion 112. As shown, path 170 shows the zig-zag path that is taken by a molecule that impacts first wall 100 and second wall 110, with centerline 172 being used to show the path of a molecule that travels roughly along the centerline of the component.

As shown, path 170 and path 172 intersect when the paths' respective molecules collide at location 178, and, as shown, the colliding molecules' paths are changed by the collision, with path 172 being deflected slightly upward along trajectory 174, and with path 170 being deflected to path 176. Wall 100 and wall 110 can define a space/volume 102a therebetween.

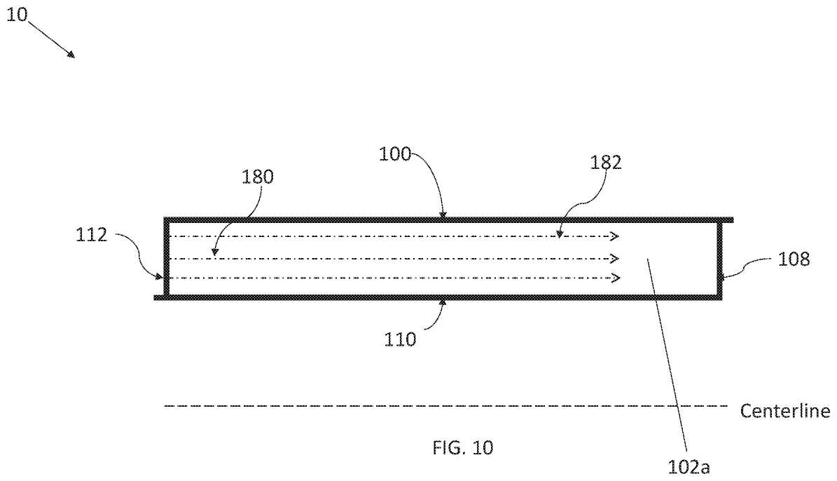

FIG. 10 provides a further depiction of an embodiment of the disclosed technology. As shown, the depicted component includes a first wall 100. The first wall can include a projection portion 108. Wall 110 can include a projection portion 112. As shown, paths 180 and 182 show the linear, parallel paths taken by molecules within the volume defined between wall 100 and wall 110.

As shown, the parallel molecular paths do not intersect one another, and because there is no exit from the volume, the molecules remain on their paths. Wall 100 and wall 110 can define a space/volume 102a therebetween.

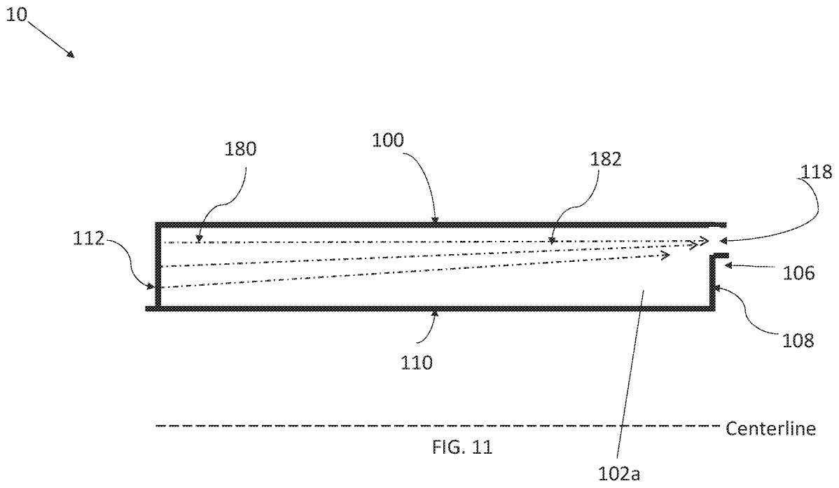

FIG. 11 provides a further depiction of an embodiment of the disclosed technology. As shown, the depicted component includes a first wall 100. The first wall can include a projection portion 108. Wall 110 can include a projection portion 112. As shown, paths 180 and 182 now point toward vent 118, which vent is defined between land 106 and first wall 100. Wall 100 and wall 110 can define a space/volume 102a therebetween.

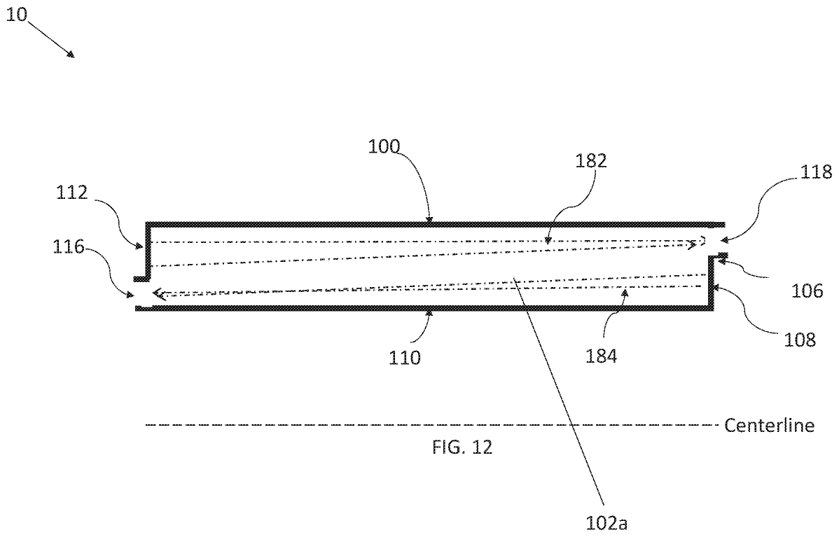

FIG. 12 provides a further depiction of an embodiment of the disclosed technology. As shown, the depicted component includes a first wall 100. The first wall can include a projection portion 108. Wall 110 can include a projection portion 112. As shown, paths 180 and 182 now point toward vent 118, which vent is defined between land 106 and first wall 100.

A second vent 116 is defined between the land (not shown) of first wall 100 and the second wall 110, and a first vent is defined between land 106 of second wall 110 and first wall 100. Wall 100 and wall 110 can define a space/volume 102a therebetween.

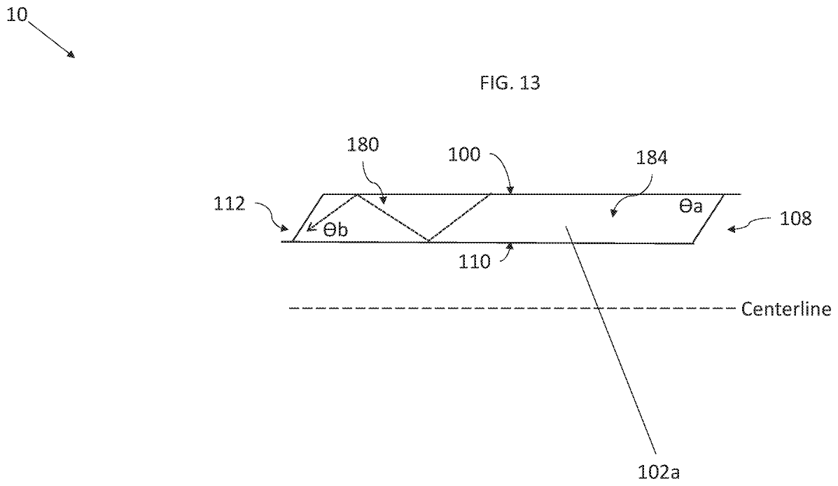

FIG. 13 provides a further depiction of an embodiment of the disclosed technology. More specifically, the depicted component includes a first wall 100. The first wall can include a projection portion 108, which can project at an angle θa from the main portion of the first wall. The angle θa can be from about 1 to about 180 degrees, and all values and ranges therein.

Wall 110 can include a projection portion 112, which can project at an angle θb from second wall 110. The angle θb can be from about 1 to about 180 degrees. Without being bound to any particular theory, angle θa and angle θb can be selected such that projection portions 108 and 112 act to deflect molecules moving within the space defined between wall 100 and wall 110 toward a vent located opposite the projection portion. Wall 100 and wall 110 can define a space/volume 102a therebetween.

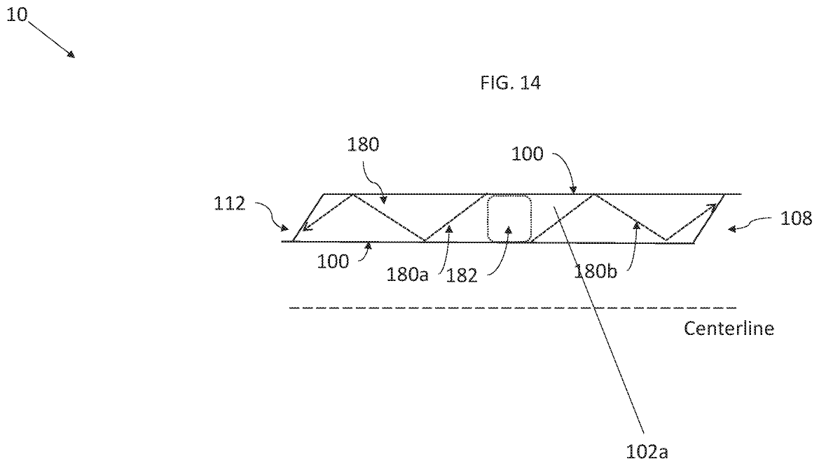

FIG. 14 provides a further depiction of an embodiment of the disclosed technology. More specifically, the depicted component includes a first wall 100. The first wall can include a projection portion 108, which can project at an angle θa (not shown) from the main portion of first wall. The angle θa can be from about 1 to about 180 degrees, and all values and ranges therein.

Wall 110 can include a projection portion 112, which can project at an angle θb from second wall 110. The angle θb can be from about 1 to about 180 degrees. Without being bound to any particular theory, angle θa and angle θb can be selected such that projection portions 108 and 112 act to deflect molecules moving within the space defined between wall 100 and wall 110 toward a vent located opposite the projection portion.

As shown, a molecule following path 180a can be directed to a vent that is at least partially defined by projection portion 108 or 112. Likewise, a molecule following path 180b can be directed to a vent that is at least partially defined by projection portion 108 or 112. Region 182 is shown to illustrate the region of “dead space” that is not most efficiently evacuated when using traditional techniques to evacuate sealed volumes. Wall 100 and wall 110 can define a space/volume 102a therebetween.

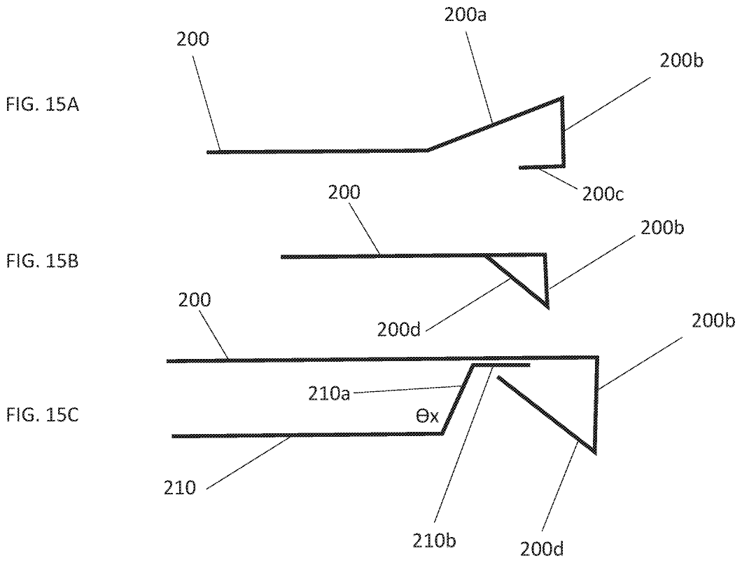

FIGS. 15A, 15B, and 15C provide depictions of various wall embodiments. As shown in FIG. 15A, wall 200 can include a first diverging portion 200a, which can flare outwards at an end of the wall. The wall can also include end portion 200b, which portion can taper inwards from diverging portion 200a. The wall can also include curl portion 200c, which can curl back from end portion 200b.

FIG. 15B provides a depiction of a wall embodiment. As shown wall 200 includes an end portion 200b and a curl portion 200d, which curl portion curls back (e.g., via pinching) against wall 200.

FIG. 15C provides a further depiction of a wall embodiments. As shown, wall 200 includes end portion 200b and curl portion 200d. Second wall 210 includes flare portion 210a that flares outward at angle θx from wall 210. (Angle θx can be from 1 to 180 degrees, but is preferably about 90 degrees.

As shown, wall 210 can include seal portion 210b, which can be inserted into a space between wall 200 and curl portion 200d, following which curl portion 200d can be pinched or otherwise exerted against seal portion 210a to make a sealed space defined between wall 200 and wall 210. Without being bound to any particular embodiment, walls 200 and 210 can be friction-fit against one another. In one such embodiment, wall 210 can exert a spring-back against curl portion 200d.

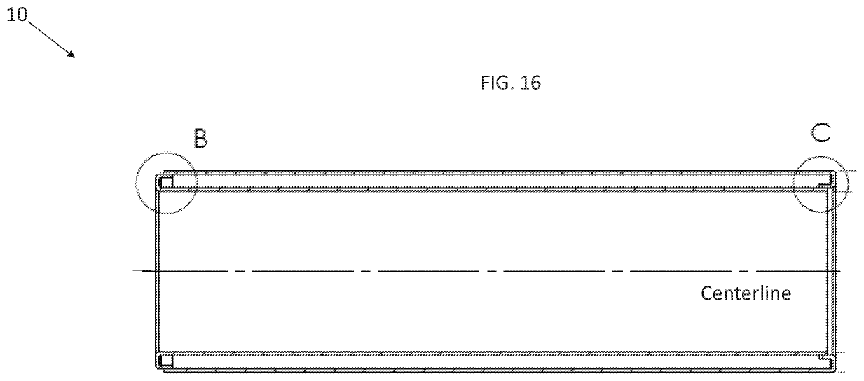

FIG. 16 provides a cutaway view of a component, comprising a sealed annular space, according to the present disclosure.

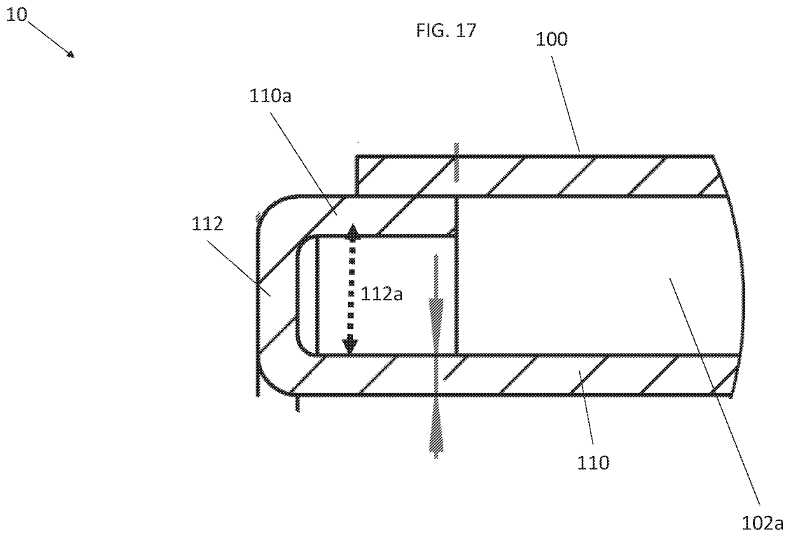

FIG. 17 provides a cutaway close up of region “B” from FIG. 16. As shown, first wall 100 can be sealed to curl portion 110a of second wall 110; curl portion 110a suitably extends from end portion 112. Height 112a can be defined between curl portion 110a and wall 110. Height 112a is suitably from about 1:1000 to about 1:2 of the length of the space 102a defined between walls 100 and 110.

In some embodiments, curl portion 110a can exert a springback against wall 100. In other embodiments, wall 100 can exert a compression against curl portion 110a, e.g., when the inner diameter of wall 100 is less than the outer diameter of curl portion 110a.

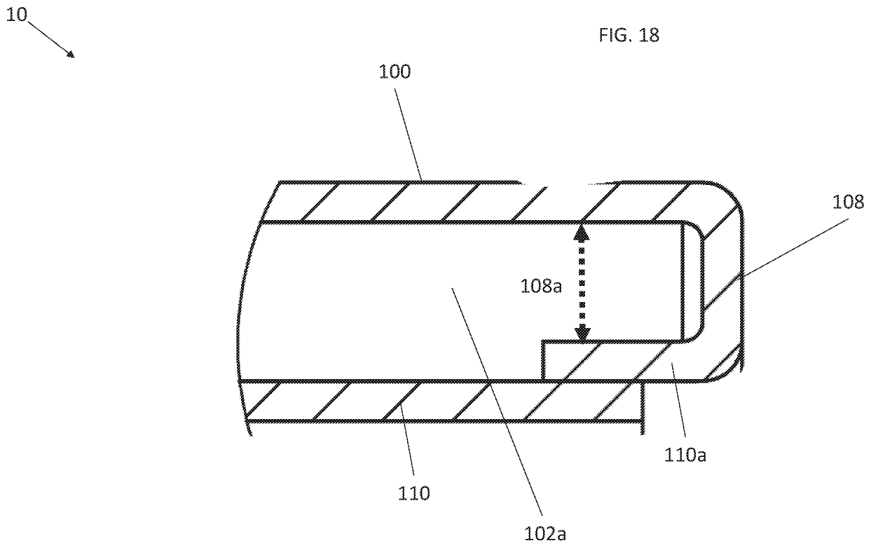

FIG. 18 provides a cutaway close up of region “C” from FIG. 16. As shown, first wall 100 can include projection 108 and curl portion 110a, which can also be termed a “land.” Wall 110 is suitably sealed to curl portion 108a. Height 108a can be defined between curl portion 108a and wall 110. Height 108a is suitably from about 1:1000 to about 1:2 of the length of the space 102a defined between walls 100 and 110.

In some embodiments, curl portion 110a can exert a springback against wall 110. In other embodiments, wall 110 can exert a compression against curl portion 110a, e.g., when the inner diameter of wall 100 is less than the outer diameter of curl portion 110a.

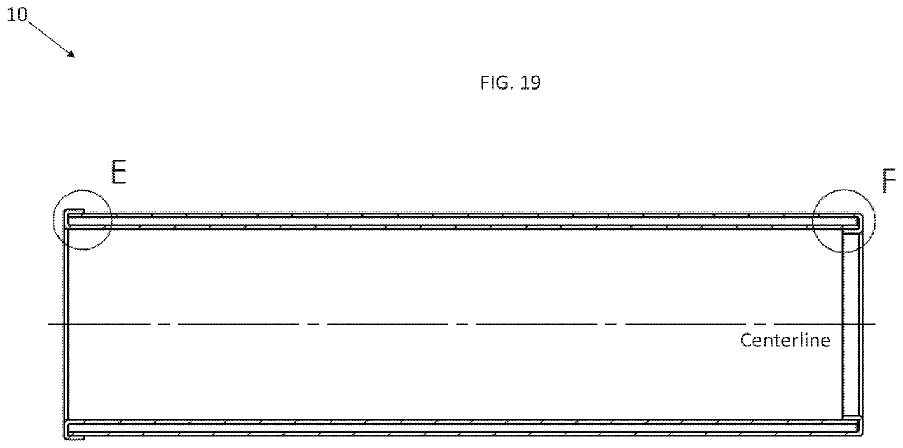

FIG. 19 provides a cutaway view of a component, comprising a sealed annular space, according to the present disclosure.

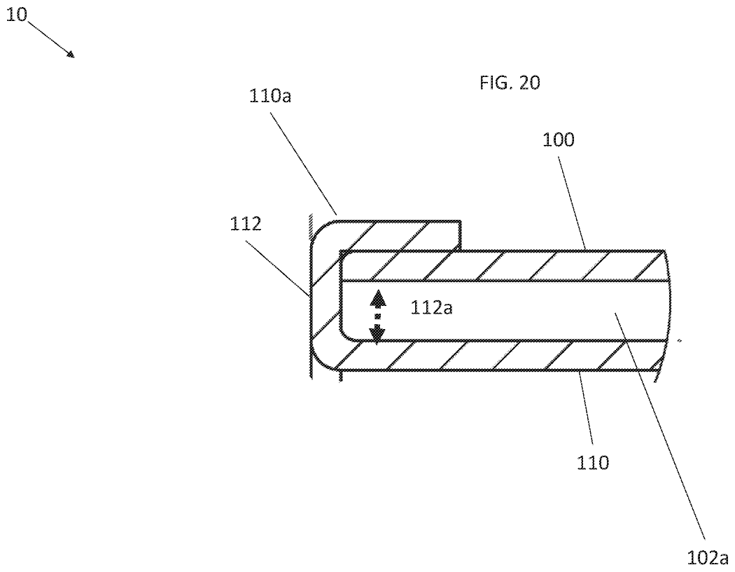

FIG. 20 provides a cutaway close up of region “E” from FIG. 19. As shown, first wall 100 can be sealed to curl portion 110a of second wall 110; curl portion 110a suitably extends from end portion 112.

Height 112a can be defined between curl portion 110a and wall 110. Height 112a is suitably from about 1:1000 to about 1:2 of the length of the space 102a defined between walls 100 and 110.

In some embodiments, wall 100 can springback against curl portion 110a. In other embodiments, curl portion 110a can exert a compression against wall 100, e.g., when the inner diameter of curl portion 110a less than the outer diameter of wall 100.

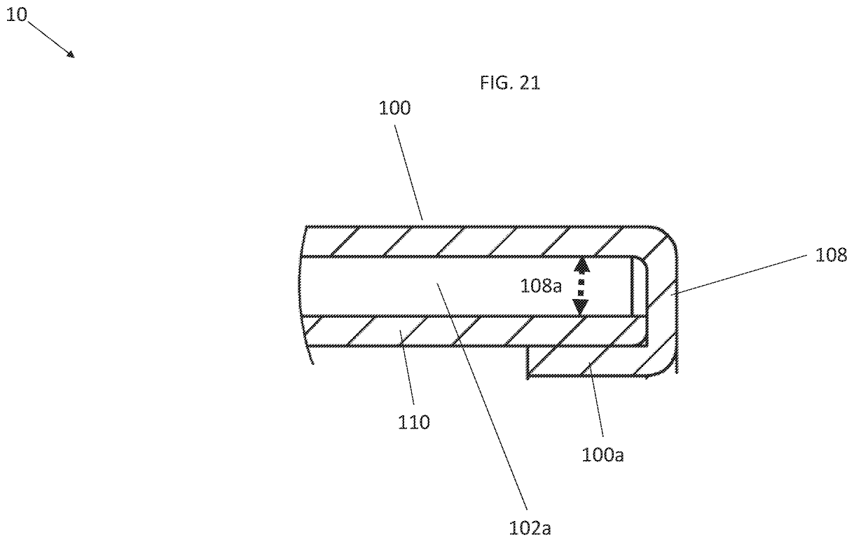

FIG. 21 provides a cutaway close up of region “F” from FIG. 16. As shown, first wall 100 can include projection 108 and curl portion 110a, which can also be termed a “land.” Wall 110 is suitably sealed to curl portion 108a. Height 108a can be defined between curl portion 108a and wall 110. Height 108a is suitably from about 1:1000 to about 1:2 of the length of the space 102a defined between walls 100 and 110.

In some embodiments, wall 110 can springback against curl portion 100a. In other embodiments, curl portion 100a can exert a compression against wall 110, e.g., when the inner diameter of curl portion 100a is less than the outer diameter of wall 110.

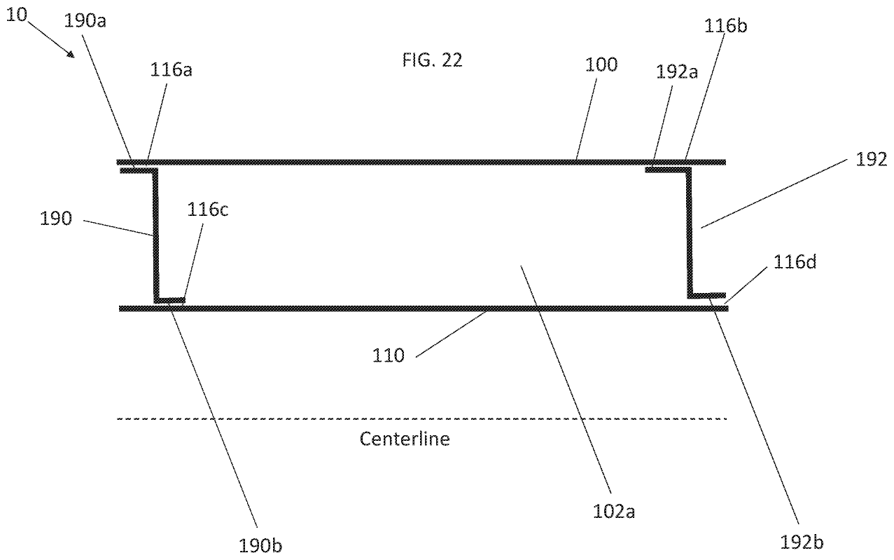

FIG. 22 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110.

As shown in FIG. 22, first cap 190 defines a height that is less than or about equal to the distance between walls 100 and 110. As shown in FIG. 22, lands 190a and 190b can extend in opposite directions, relative to one another. A component can include a second cap 192, which second cap can include lands 192a and 192b. Lands 192a and 192b can be sealed, respectively, to walls 100 and 110.

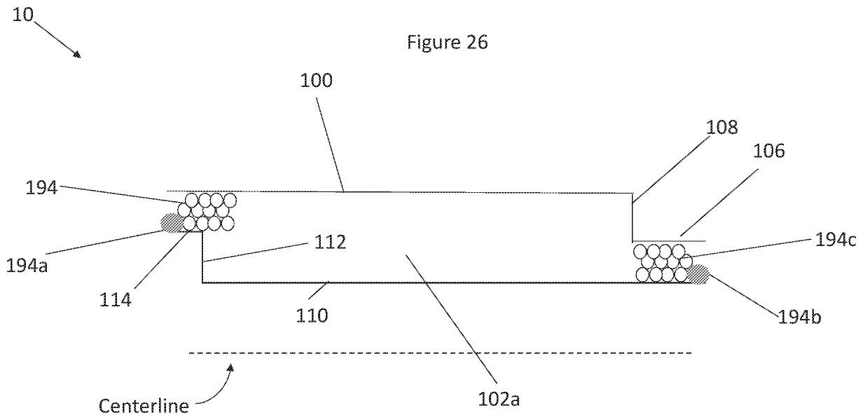

Sealing can be effected by various techniques known in the art, including, e.g., brazing, adhesives, welding, sonic welding, and the like. Sealing can be effected by, e.g., processing a circumferential ribbon of braze material. Sealing can also be effected by processing an amount of sealing material (e.g., braze material) has been disposed within a porous support material, e.g., a porous ceramic. Sealing material can be heated to as to at least partially soften or even liquefy. In its softened/liquefied form, the sealing material can be drawn into the porous support material, e.g., by wicking and/or capillary action. Sealing material can also be drawn and/or forced into the support material by application of a pressure gradient that effects movement of the sealing material into the support material. An example of this is found in non-limiting FIGS. 26-28.

As shown, lands 192a and 192b can extend in opposite directions, relative to one another. Space 102a can be at or below ambient pressure. Also as shown in FIG. 22, lands 190a, 190b, 192a, and 192b can be overlapped by one or both of walls 100 and 110. As shown in FIG. 22, land 190a defines a vent with wall 100, land 190b defines a vent with wall 110, land 192a defines a vent with wall 100, and land 192b defines a vent with wall 110.

The vents can be sealed simultaneously, but can also be sealed in a sequence. As one example, a user can first seal the vents defined by land 190a and wall 100 and land 192b and wall 110. In this way, the vents defined by land 190b and wall 100 and land 192a and wall 100 remain open and positioned diagonally (within space 102a) across from one another. It should be understood that either or both of caps 190 and 192 can be friction-fit against one or both of walls 100 and 110.

Without being bound to any particular theory, the configuration in FIG. 22 (and in other disclosed embodiments) allows for multiple avenues by which molecules present in the space 102a between the walls (e.g., 100 and 110) can transit out of that space. As shown, vent 116a is formed with wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

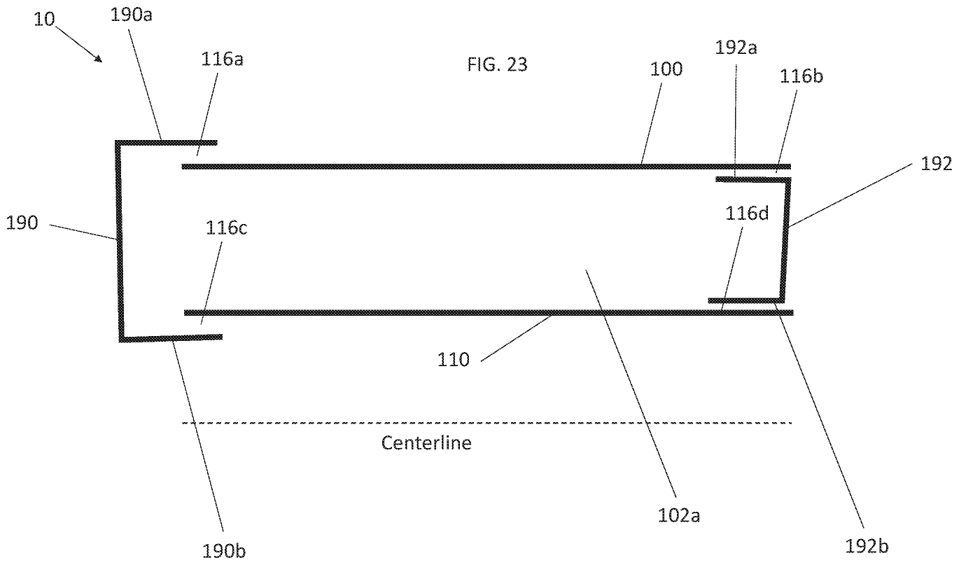

FIG. 23 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110. As shown in FIG. 2, first cap 190 defines a height that is less than or about equal to the distance between walls 100 and 110.

As shown in FIG. 23, lands 190a and 190b can extend in or about in the same direction, relative to one another. A component can include a second cap 192, which second cap can include lands 192a and 192b. Lands 192a and 192b can be sealed, respectively, to walls 100 and 110.

As shown in FIG. 23, cap 192 can define a height that is less than or about equal to the distance between walls 100 and 110. Sealing can be effected by various techniques known in the art, including, e.g., brazing, adhesives, welding, sonic welding, and the like. Cap 190 can be constructed such that lands 190a and 190b overlap the exterior of walls 100 and 110.

As shown, lands 192a and 192b can extend in or about in the same direction, relative to one another. Space 102a can be at or below ambient pressure. As shown in FIG. 23, one or both of caps 190 and 192 can be convex relative to space 102a.

Also as shown in FIG. 23, lands 190a, 190b, 192a, and 192b can be overlapped by one or both of walls 100 and 110. As shown in FIG. 23, land 190a defines a vent with wall 100, land 190b defines a vent with wall 110, land 192a defines a vent with wall 100, and land 192b defines a vent with wall 110. The vents can be sealed simultaneously, but can also be sealed in a sequence. As one example, a user can first seal the vents defined by land 190a and wall 100 and land 192b and wall 110. In this way, the vents defined by land 190b and wall 100 and land 192a and wall 100 remain open and positioned diagonally (within space 102a) across from one another. It should be understood that either or both of caps 190 and 192 can be friction-fit against one or both of walls 100 and 110.

Without being bound to any particular theory, the configuration in FIG. 23 (and in other disclosed embodiments) allows for multiple avenues by which molecules present in the space 102a between the walls (e.g., 100 and 110) can transit out of that space. As shown, vent 116a is formed with wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

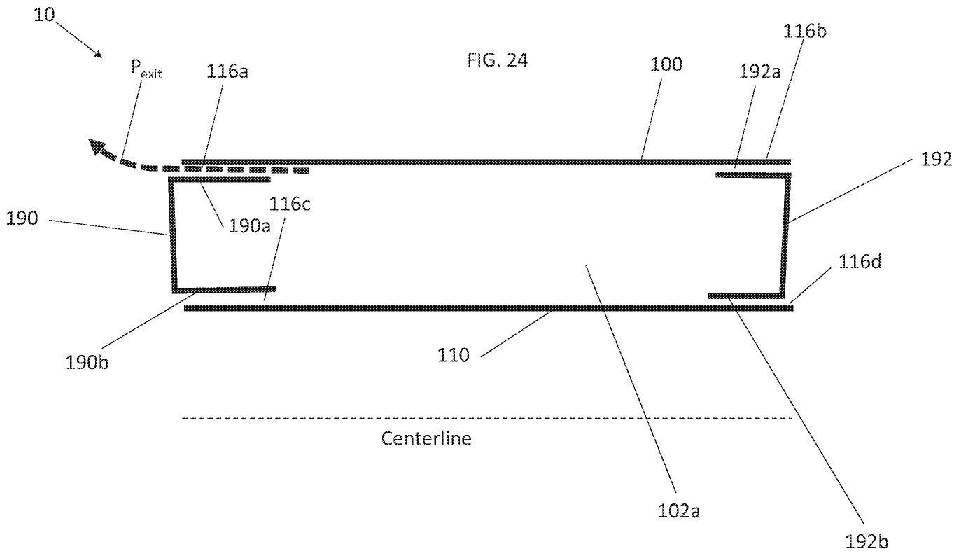

FIG. 24 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110.

As shown in FIG. 24, first cap 190 defines a height that is less than or about equal to the distance between walls 100 and 110. As shown in FIG. 24, lands 190a and 190b can extend in or about in the same direction, relative to one another. A component can include a second cap 192, which second cap can include lands 192a and 192b. Lands 192a and 192b can be sealed, respectively, to walls 100 and 110.

As shown in FIG. 24, first cap 190 can define a height that is less than or about equal to the distance between walls 100 and 110. Sealing can be effected by various techniques known in the art, including, e.g., brazing, adhesives, welding, sonic welding, and the like.

As shown, lands 192a and 192b can extend in or about in the same direction, relative to one another. Space 102a can be at or below ambient pressure. As shown in FIG. 24, one or both of caps 190 and 192 can be convex relative to space 102a. Also as shown in FIG. 24, a land and a wall (e.g., land 190a and wall 100) can be arranged such that the land overlaps the wall, rather than the wall (e.g., land 190b and wall 110) overlapping the land.

It should be understood that either or both of caps 190 and 192 can be friction-fit against one or both of walls 100 and 110.

Without being bound to any particular theory, the configuration in FIG. 22 (and in other disclosed embodiments) allows for multiple avenues by which molecules present in the space 102a between the walls (e.g., 100 and 110) can transit out of that space. As shown, vent 116a is formed with (i.e., between) wall 100 and land 190a of cap 190, vent 116c is formed with wall 110 and land 190b of cap 190, vent 116b is formed with wall 100 and land 192a of cap 192, and vent 116d is formed by land 192b and wall 110. In this way, molecules present in the space 102a have multiple avenues for egress.

As shown in FIG. 24, molecules that exit space 102a can follow an exit path shown by Pₑₓᵢₜ. As shown, the exit path is toward or in the direction of the end of wall 100 and away from the end of land 190a. Although this path is shown in the context of FIG. 24, it should be understood that the illustration with FIG. 24 is illustrative, and that the present disclosure contemplates such an exit path (i.e., in a direction toward the end of one wall (or land) of a component and away from the end of another wall (or land) of the component.

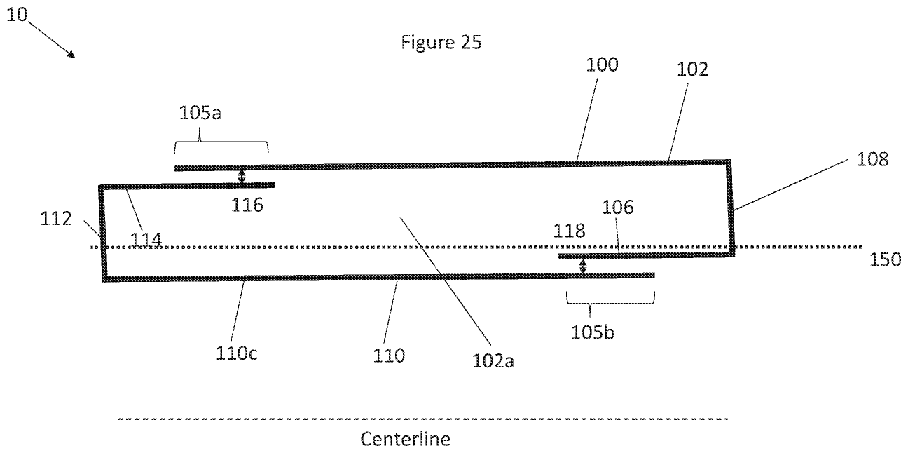

FIG. 25 provides an exemplary depiction of a component 10 according to the present disclosure. As shown, component 10 includes first wall 100, which first wall can define a main portion 102. The first wall can include a projection portion 108, which can optionally project perpendicular from the main portion, though this is not a requirement. Projection portion can define a length 104. The first wall can also include a land portion 106, which land portion can extend in the same direction as main portion 102. As shown, vent 118 can be defined between land portion 106 and second wall 110. Land 106 can also overlap by a distance 105b with second wall 110.

As shown, vent 118 can be disposed at a distance from projection portion 108, i.e., vent 118 need not be at the end of the component and can be located at essentially any location along wall 110.

Second wall 110 can include a main portion 110c. Second wall 110 can also include projection portion 112, which can optionally project perpendicular from second wall 110. Second wall 110 can also include land portion 114; as shown, land portion 114 can extend in the same direction as main portion 110c. A second vent 116 can be defined between the first wall and the second wall.

Land 114 can also overlap by a distance 105a with first wall 100. As shown, a line 150 that is parallel to the major axis of the space defined between first wall 100 and second wall 110 can be drawn.

In some embodiments, such a parallel line does not intersect both first vent 116 and second vent 118. Wall 100 and wall 110 can define a space/volume 102a therebetween. As shown, vent 116 can be disposed at a distance from projection portion 112, i.e., vent 118 need not be at an end of the component and can be located at essentially any location along wall 100.

It should be understood that a component according to the present disclosure can include only one vent, although multiple vents can also be used. It should also be understood that vents can be sealed via techniques known to those of ordinary skill in the art, e.g., brazing, welding, adhesive, and the like. Without being bound to any particular theory, by locating a vent further from an end of the component and closer to a midpoint of the component, one can more effectively evacuate the space defined between the walls of the component because it can be easier to draw molecules closer to the vent. Without being bound to any particular embodiment, walls 100 and 110 can be friction fit against one another, e.g., where one or both of land 114 and wall 100 exerts against the other. Likewise, one or both of land portion 106 and wall 110 can exert against the other.

FIG. 26 provides a cutaway view of an exemplary component 10 according to the present disclosure, showing an illustrative wall configuration. As shown in FIG. 26, first wall 100 can include projection portion 108, which can optionally project perpendicular from wall 100, although this (optional perpendicular projection) is not a requirement. Wall 100 can also include land portion 106, which land portion can optionally project perpendicular from projection portion 108.

Second wall 110 can include projection portion 112, which can optionally project perpendicular from wall 110, although this (optionally perpendicular projection) is not a requirement. Wall 110 can also include land portion 114, which land portion can optionally project perpendicular from projection portion 112. Walls 100 and 110 can define space/volume 102a therebetween.

As shown, material 194 can be disposed between wall 100 and land portion 114. The ceramic material can be in particulate form. Material 194 can be a ceramic material. Material 194 can also be in porous form, e.g., as a ribbon or ring of porous material. An amount 194a of braze material can be disposed adjacent to material 194. The braze material can be present as a ring, ribbon, or in other form. The braze material may be disposed circumferentially about some or all of the space (not labeled) between wall 100 and land portion 114.

As shown, material 194c can be disposed between wall 110 and land portion 106. The ceramic material can be in particulate form. Material 194c can be a ceramic material. Material 194c can also be in porous form, e.g., as a ribbon or ring of porous material. An amount 194b of braze material can be disposed adjacent to material 194c. The braze material can be present as a ring, ribbon, or in other form. The braze material may be disposed circumferentially about some or all of the space (not labeled) between wall 110 and land portion 106.

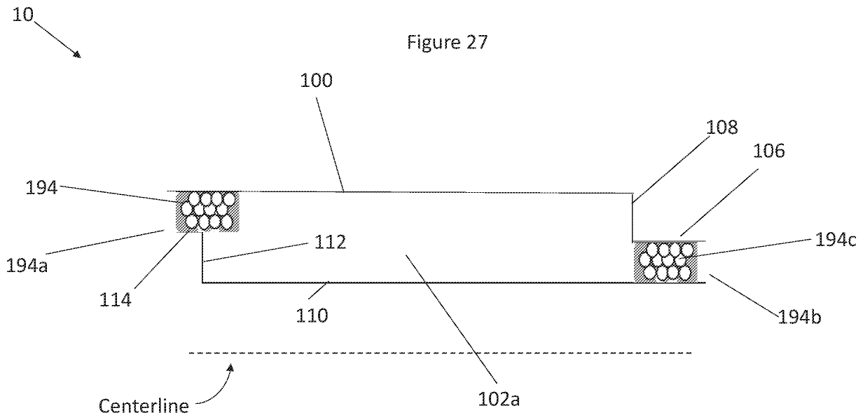

FIG. 27 provides a cutaway view of the component 10 shown in FIG. 26. As shown in FIG. 27, braze materials 194a and 194b have been processed (e.g., via heating) so as to become disposed within materials 194 and 194c. By reference to braze material 194a and material 194 (and also without being bound to any particular theory), braze material 194a can be heated to as to at least partially soften or even liquefy. In its softened/liquefied form, braze material 194a is drawn into material 194, e.g., by wicking and/or capillary action. Braze material 194a can also be drawn and/or forced into material 194 by application of a pressure gradient that effects movement of braze material 194a into material 194.

Again with reference to braze material 194a and material 194, after braze material 194a is disposed within material 194, braze material 194a (e.g., after re-hardening) acts to seal space 102a against the environment exterior to the component 12, as the braze material 194a fills in the spaces/voids within material 194a.

As a non-limiting example, braze material 194a can be selected such that it liquefies at a certain temperature TL. Component 10 can be heated in an environment that is at a temperature that is less than TL such that molecules disposed within space 102a become excited and exit space 102a. Following the exit of at least some of the molecules from space 102a, the temperature experienced by component 10 can be raised to a temperature about TL such that braze material 194a liquefies and becomes disposed within material 194.

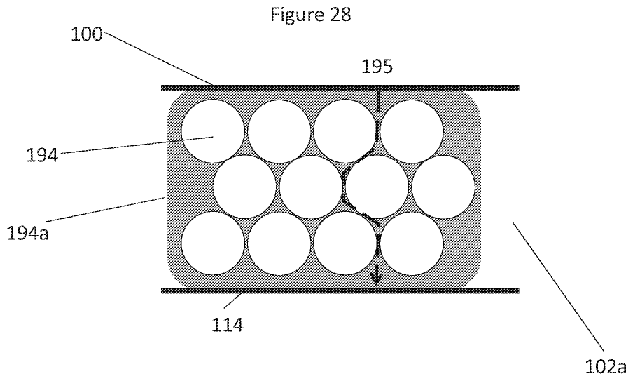

FIG. 28 provides a close-up cutaway view of a joint region of the exemplary component of FIGS. 26 and 27. As shown in FIG. 28, braze material 194a is disposed within material 194. In the exemplary embodiment of FIG. 28, material 194 is present as spheres, and braze material 194a has become disposed within the spaces between spheres. Also as shown in FIG. 28, the composite of braze material 194a and material 194 seals the space between wall 100 and land portion 114, so as to seal space 102a against the exterior environment.

Path 195 in FIG. 28 shows—without being bound to any particular theory—the pathway that heat would take between wall 100 and land portion 114. As shown, path 195 is tortuous and non-linear, as heat passing between wall 100 and land portion 114 cannot go directly through the relatively insulating material 194 and must instead travel within relatively conducting braze material 194. In this way, the relative insulating capability of the seal formed by braze material 194a and material 194 is greater (i.e., more insulating) than a seal that is formed entirely of braze material 194a. Without being bound by any particular theory, the disclosed approach acts to lengthen the pathway that heat must take to travel between wall 100 and land portion 114.

In addition, because some of the volume of the space between wall 100 and land portion 114 is occupied by material 194, a user can use relatively less braze material 194a to seal the space between wall 100 and land portion 114 than if there were no other material disposed in that space and the space were sealed with only braze material.

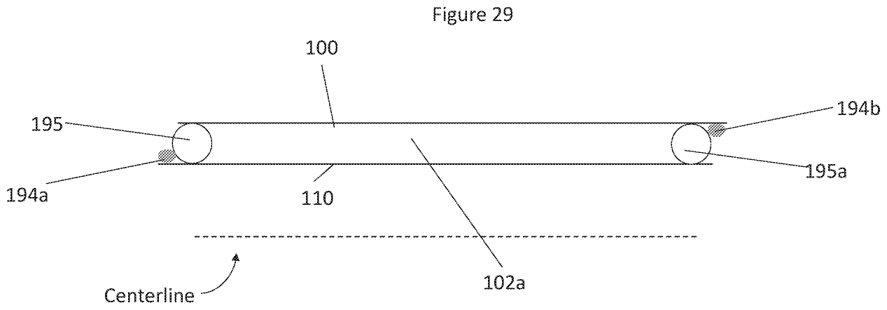

FIG. 29 provides a cutaway view of an exemplary component according to the present disclosure, showing an illustrative wall configuration. As shown in FIG. 29, walls 100 and 110 define a space 102a there between. By reference to the left side of the figure, a sealing material 195 can be disposed in the space between walls 100 and 110. The sealing material can be present in the form of a ring, e.g., a toroid. Although the cross-section of sealing material 195 is shown as circular, this is illustrative only, as the sealing material can be circular, ovoid, polygonal, or have some other cross-section. An amount 194a of braze material can be disposed adjacent to material 194. The braze material can be present as a ring, ribbon, or in other form. The braze material may be disposed circumferentially about some or all of the space (not labeled) between wall 100 and wall 110. Sealing material 195 can be sized so that it has a cross-sectional dimension (e.g., diameter) that is slightly less than the distance separating wall 100 and wall 110.

A sealing material can comprise a ceramic. A sealing material can be a material that has a lower thermal conductivity than a braze material used in a given component.

By reference to the right side of the figure, a sealing material 195a can be disposed in the space between walls 100 and 110. The sealing material can be present in the form of a ring, e.g., a toroid. Although the cross-section of sealing material 195a is shown as circular, this is illustrative only, as the sealing material can be circular, ovoid, polygonal, or have some other cross-section. An amount 194b of braze material can be disposed adjacent to material 195a. The braze material can be present as a ring, ribbon, or in other form. The braze material may be disposed circumferentially about some or all of the space (not labeled) between wall 100 and wall 110. Sealing material 195a can be sized so that it has a cross-sectional dimension (e.g., diameter) that is slightly less than the distance separating wall 100 and wall 110. Braze material 194a and 194b can be heated to a temperature such that the braze material enters and/or is encouraged into any spaces between sealing material 195 and 195a and walls 100 and 110. The braze material then solidifies, thereby forming a seal with sealing material 195 and 195a so as to seal space 102a against the exterior environment. (As described elsewhere herein, space 102a can be at least partially evacuated.)

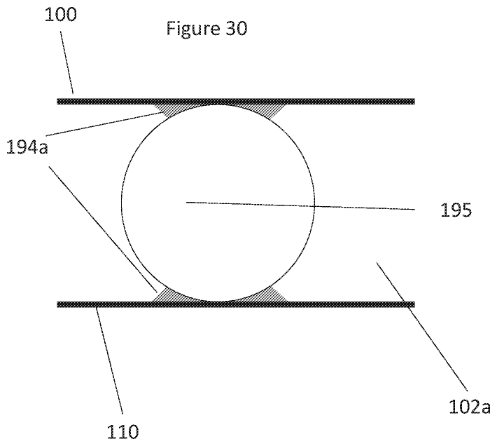

FIG. 30 provides a close-up cutaway view of a seal according to FIG. 30. As shown, braze material 194a has been disposed in the spaces between walls 100 and 110 and sealing material 195, so as to seal space 102a against the exterior environment. By using the disclosed approach, a user can form a seal between walls 100 and 110 that uses less braze material than if sealing material 195 were not present. Further, because sealing material 195 can be lower in thermal conductivity than braze material 194a, a seal formed according to the present disclosure will support less heat flow between walls 100 and 110 than a seal formed entirely of braze material. Further, a seal according to the present disclosure does not provide a complete path through (relatively conductive) braze material between walls 100 and 110. In this way, a seal according to the present disclosure can support less heat flow between walls 100 and 110 than a seal formed entirely of braze material.

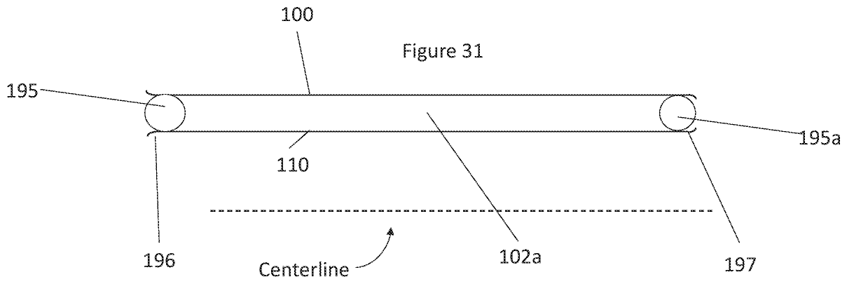

FIG. 31 provides a cutaway view of an exemplary component according to the present disclosure, showing an illustrative wall configuration. By reference to the left side of the figure, sealing material 195 can be disposed in the space between walls 100 and 110. One or both of walls 100 and 110 can include a flared portion (e.g., flared portion 196 of wall 110), which flared portion can be adjacent to sealing material 195. Without being bound to any particular theory, a flared portion of a wall can provide a space into which a braze material (not shown) can more easily fit and flow into a space between the sealing material and the wall.

A wall can also include a curled portion (e.g., curled portion 197 of wall 110). The curled portion can at least partially enclose a sealing material, shown as 197 in FIG. 31. Without being bound to any particular theory, a curled portion can assist in maintaining a sealing material in position. Also without being bound to any particular theory, a curled portion can provide a space into which a braze material (not shown) can more easily fit and flow into a space between the sealing material and the wall.

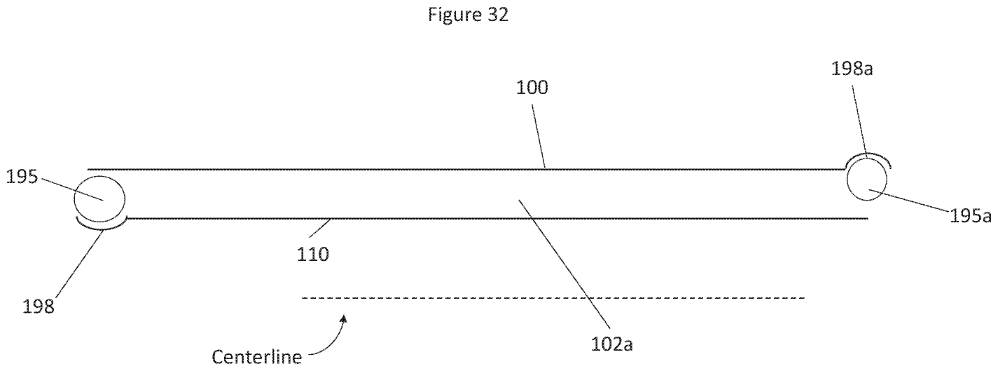

FIG. 32 provides a cutaway view of an exemplary component according to the present disclosure, showing an illustrative wall configuration. As shown, wall 110 can include a cupped portion 198, into which cupped portion sealing material 195 can fit. Wall 100 can also include a cupped portion 198a, into which cupped portion sealing material 195a can fit. Without being bound to any particular theory, a cupped portion can assist in positioning a sealing material and/or maintaining the sealing material in position. Brazing material (not shown) can be used to seal spaces between sealing material and adjacent walls, including spaces between a sealing material and a cupped portion.

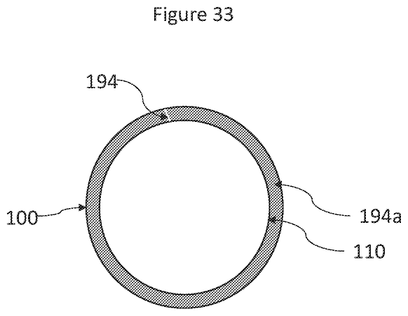

FIG. 33 provides a cross-sectional view of a joint region of an exemplary component according to the present disclosure. More specifically, FIG. 33 provides an end-on view of a component according to FIG. 28. As shown, the space (not labeled) between walls 100 and 110 has been sealed by the combination of material 194 and braze material 194. The seal is, in FIG. 33, annular in form.

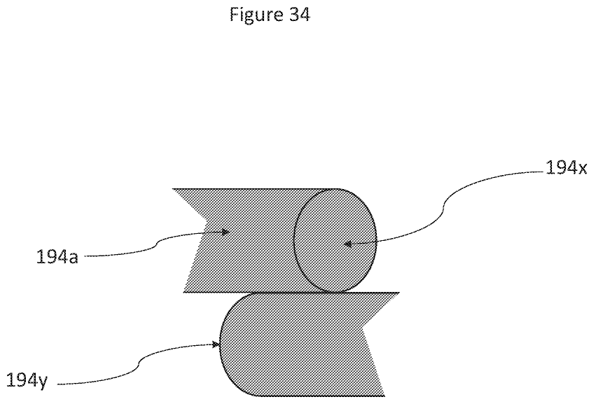

FIG. 34 provides a close-up view of the ends of a ring of braze material in a component according to the present disclosure. As shown, braze material 194a can be present in a ring form, with ends 194x and 194y being disposed nearby to one another and overlapping such that the ring of braze material extends through a complete circle. Although not shown, ends 194x and 194y can face one another. It is not a requirement that the braze material be a complete circle, as the braze material can still form a circumferential seal after the braze material is liquefied.

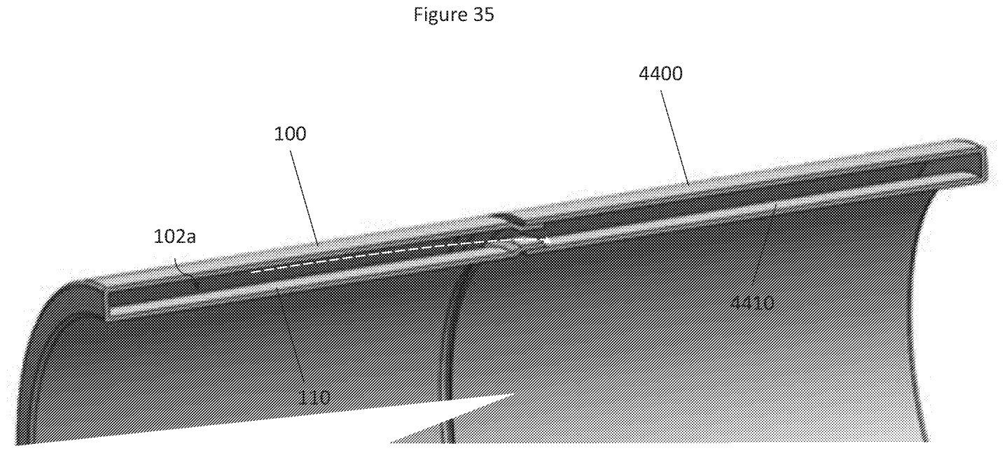

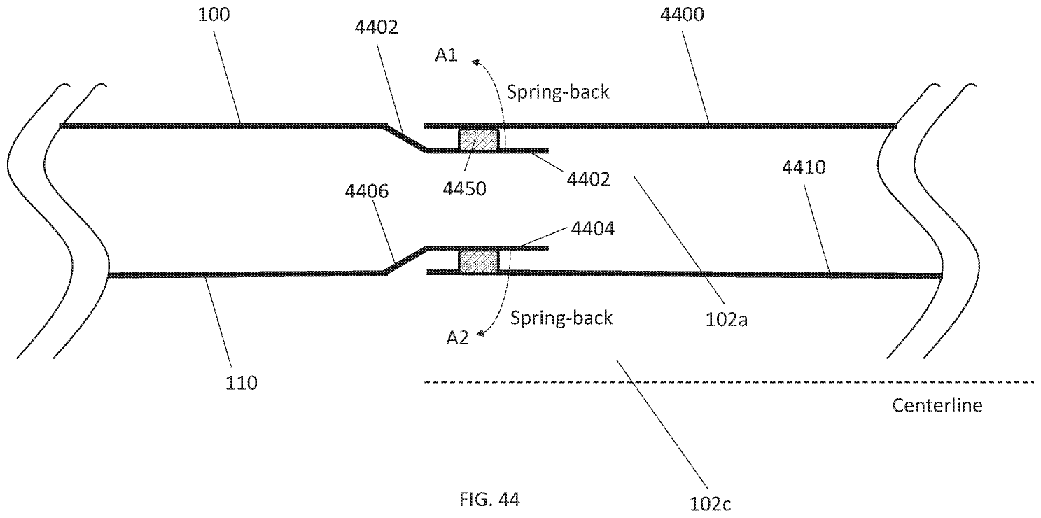

FIG. 35 provides a cutaway view of a component according to the present disclosure, similar to FIG. 44. As shown, the component can include wall 100, which wall can include a sloped portion (not labeled sloped portion 4402 connected with wall 100, and land 4402; the component can also include wall 100, sloped portion 4406, and land 4404. A sealed joint can be formed, e.g., by sealing material (such as braze material) 4450, which join in turn effects sealed space/volume 102a formed between walls 100, 110, 4400, and 4410. (Space/volume 102a can be evacuated.)

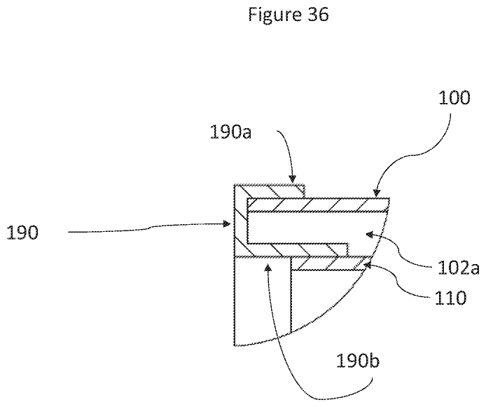

FIG. 36 provides a cutaway view of an exemplary component according to the present disclosure. As shown, cap 190 can seal the space 102a between wall 100 and wall 110. Cap 190 can include first land 190a and second land 190b. As shown, first land 190a can be disposed exterior to wall 100, and second land 190b can be disposed between wall 100 and wall 110. Land 190a can be sealed to wall 100 in virtually any way, e.g, brazing, welding, and the like. Land 190b can be sealed to wall 110 via brazing, including by any of the methods provided in the instant disclosure. Although not shown, one or more of wall 100, wall 110, and cap 190 can include one or more locator features (e.g., a ridge, a groove, a dimple, a bump) configured to facilitate locating or maintaining in place cap 190 relative to one or both of walls 100 and 110.

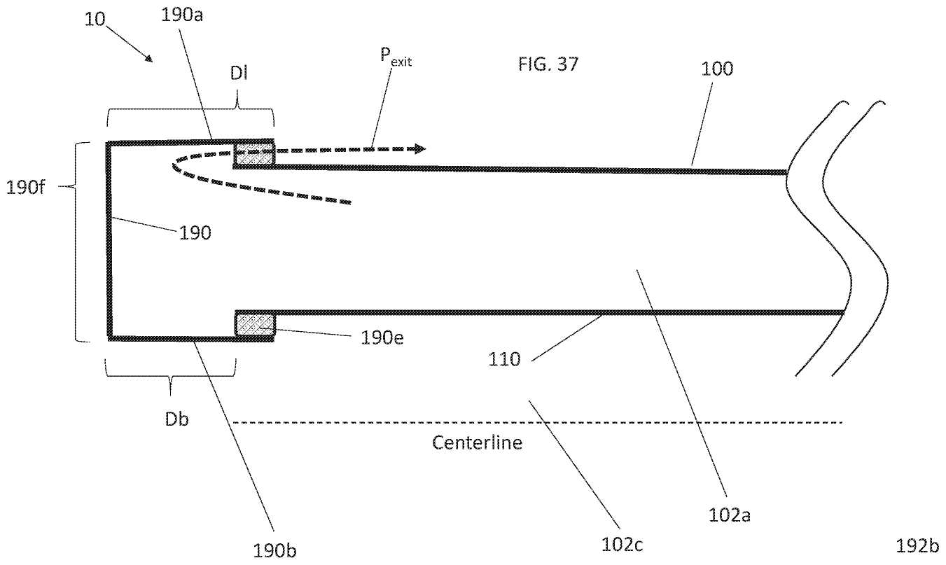

FIG. 37 provides a cutaway view of a component according to the present disclosure. As shown, walls 100 and 110 define a space 102a therebetween. A first cap 190 can include lands 190a and 190b. Lands 190a and 190b can be sealed, respectively, to wall 100 and wall 110. As shown in FIG. 2, first cap 190 defines a height that is less than or about equal to the distance between walls 100 and 110.

As shown in FIG. 37, lands 190a and 190b can extend in or about in the same direction, relative to one another. As shown, land 190a defines a length Dl.

Also as shown in FIG. 37, lands 190a and 190b can overlap the ends of walls 100 and 110. As shown in FIG. 37, land 190a defines a vent with wall 100 and land 190b defines a vent with wall 110. The vents can be sealed simultaneously, but can also be sealed in a sequence. Although not shown, a second cap (not shown) having the same shape as cap 190 can be sealed to the other ends of walls 100 and 110. The second cap can also have a different shape as cap 190.

As an example, a user can seal the vents defined by land 190a and wall 100 and land 192b and wall 110 in a sequential way. A user can also seal other vents (not shown) at the other ends of walls 100 and 110 in a sequential way. Vents can be sealed simultaneously, sequentially, or a combination thereof.

Cap 190 can be friction-fit (e.g., interference fit) against one or both of walls 100 and 110. Cap 190 can be sealed to walls 100 and 100 by various techniques known in the art, including, e.g., brazing, adhesives, welding, sonic welding, and the like.

As shown in FIG. 37, braze material 190e can be used to seal cap 190 to walls 100 and 110. (As discussed elsewhere herein, brazing is but one way to effect this sealing; welding, adhesive, sonic welding, and the like can also be used.) The braze material can be located at a distance Db from the end of cap 190. As shown, Db can be less than Dl. In some embodiments, a portion of one or both of lands 190a and 190b extends (away from cap 190) beyond braze material 190e. In other embodiments, braze material 190e is essentially flush with the end of one or both of lands 190a and 190b. As shown brazing material 190e can be used to seal a vent, e.g., the first vent.

Without being bound to any particular theory, locating braze material 190e at a distance Db from the end of the component 10 (and cap 190) reduces heat transfer into (or out of) the volume (not labeled) defined within wall 110. Again without being bound by any particular theory, for heat to transfer out of the volume defined within wall 110, the heat would need to pass through sealing (e.g., braze material) 190e, along land 190b, along the end 190f of cap 190, and along at least part of land 190a. Such a comparatively long heat path can reduce the rate and/or amount of heat transferred between the volume defined within wall 110 and the environment exterior to wall 100. Further (and without being bound to any particular theory), by lengthening the distance Db, a user can reduce the rate and/or amount of heat transferred, as the illustrated configuration moves the joints and the associated connecting material (190e) away from the end (190) of the assembly.

It should be understood that the shape of cap 190 in FIG. 37 is illustrative only and does not limit the shape of the cap. As one example, one portion of the cap can be formed to taper or be otherwise configured to fit to a part or into a certain area. A cap can be symmetric, though this is not a requirement.

Without being bound to any particular theory, the thickness of end 190f can be less than the joint formed by 190b, 190e, and 110. In this way, the end can act as a thermal resistor to restrict the thermal transfer on the end of the device. This limits the conduction through the end of the device to the thermal properties of the wall of 190. (The cap can be made from essentially any material, e.g., stainless steel ceramic, and the like.)

Further, once thermal energy has moved through the thermal dam formed by 100, 190b, and 190f, a second thermal dam is encountered in the form of the joint formed by 190a, 190e, and 110. Because the thermal energy has encountered the thermal resistor of wall 190f before encountering the second thermal dam, there is less thermal energy to fill the second thermal dam before transferring the thermal energy to wall 100.

As shown in FIG. 37, molecules that exit space 102a can follow an exit path shown by Pₑₓᵢₜ. (It should be understood that Pₑₓᵢₜ is provided for illustration purposes and that molecules do not necessarily pass through braze material 190e.

As shown, the exit path is toward or in the direction of the end of wall 100 and away from the end of land 190a. Although this path is shown in the context of FIG. 37, it should be understood that the illustration with FIG. 37 is illustrative, and that the present disclosure contemplates such an exit path (i.e., in a direction toward the end of one wall (or land) of a component and away from the end of another wall (or land) of the component. The exit path of molecule leaving space 102a can this be described as doubled-back or at least partially reversing in its direction. As shown in FIG. 37 (and elsewhere herein), a joint can be formed between a first wall extending in a first direction and a second wall extending in a direction that is opposite to (or substantially opposite to) the first direction.

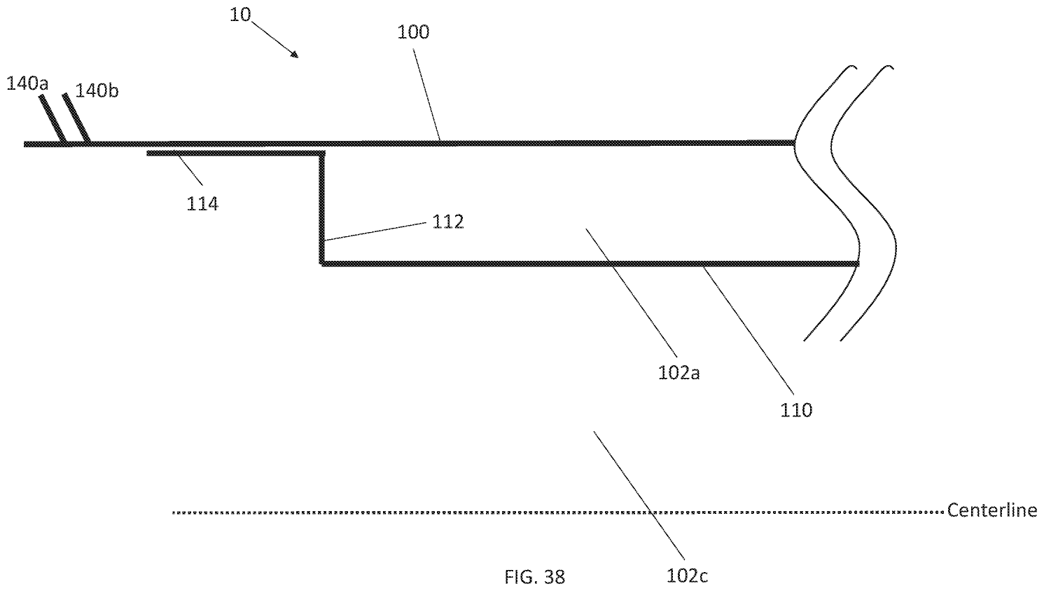

FIG. 38 provides an alternative embodiment of the disclosed technology. FIG. 1 provides an exemplary depiction of a component 10 according to the present disclosure. As shown, component 10 includes first wall 100.

A vent can be defined between first wall 100 and land portion 114 of second wall 110. Second wall 110 can also include projection portion 112, which can optionally project perpendicular from second wall 110. Second wall 110 can also include land portion 114. Land portion 114 can be sealed (e.g., via brazing) to wall 100; for clarity in the figure, the seal is not shown. Wall 100 and wall 110 can define a space/volume 102a therebetween. (It should be understood that the terms “first wall” and “second wall” are for convenience only and are not limiting. As one example, the “first wall” can be the inner wall of a double-wall tube component or the outer wall of that double-wall tube component.)

It should be understood that one or both of walls 100 and 110 can be cylindrical in configuration. In this way, the walls can define a volume (102c) within wall 110, which volume 102c can be cylindrical in shape and can have a centerline (shown in FIG. 1).

As shown in FIG. 38, a component can include one or more fins, shown as 140a and 140b. A fin can act as a heat sink and/or a heat radiator. Without being bound to any particular theory, a fin can act to retain heat that may transfer between volume 102c and the environment exterior to the component. As shown in FIG. 38, one or more fins can be disposed at an end of the component, e.g., at an end of wall 100. Fins can be disposed such that they do not overlie land 114, as shown in FIG. 38. A finned configuration has the advantage of being able to mitigate the heat transfer from the inner tube section to the outer tube section or from the outer tube section to the inner tube section. In this manner the fin configuration allows for the control of thermal energy by using convection cooling to release energy to the surrounding environment or to receive thermal energy from the surrounding environment into the apparatus. A fin/heat sink may also be used as a thermal dam. In this configuration, thermal energy is required to charge the thermal dam thus reducing the amount of thermal energy available to heat (or cool) the inner or outer wall, depending on the application

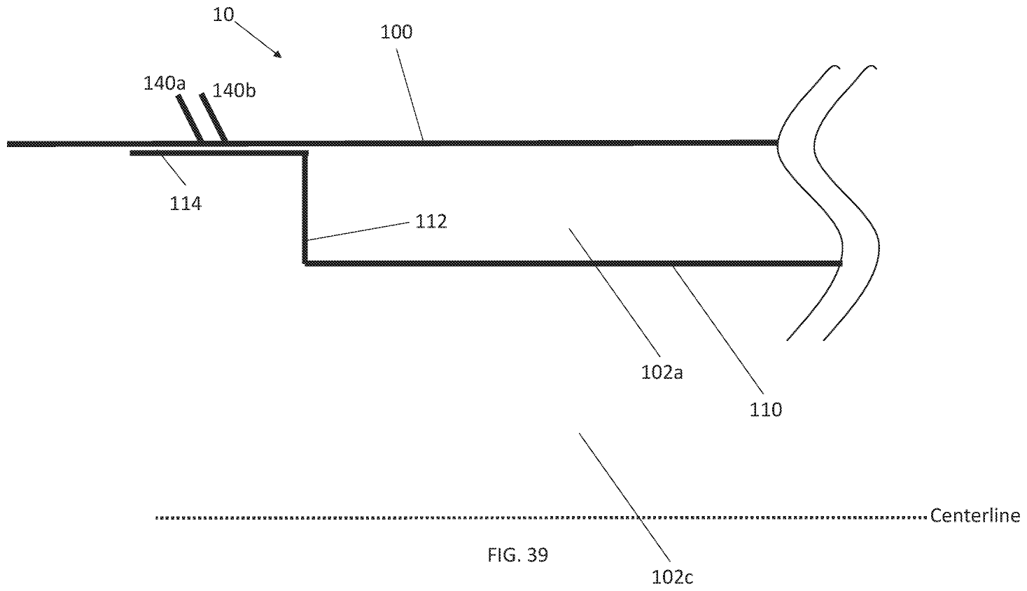

FIG. 39 provides a component similar to FIG. 38, except that fins 140a and 140b are located on wall 100 at a distance from the end of wall 100. In the embodiment shown in FIG. 39, the fins overlie land 114. In this configuration, fins can control the overall temperature of the wall which they are engaged. A heat sink placed away from the end joint connecting the inner section and the outer section of the vacuum space has the benefit of allowing the outward facing section of the device to heat or cool along the length while mitigating the temperature impact at or close to the fin configuration. This configuration can be desirable where conservation of energy is required in the application; a reduced skin temperature is also desirable. This configuration also allows the first fin formed from the outer tube (need a number for the section going from the joint to the fins) to act as a cooling device. This configuration is of particular utility if the end of the assembly is to be engaged for mounting or holding the tube and thermal profiles at this location are of interest.

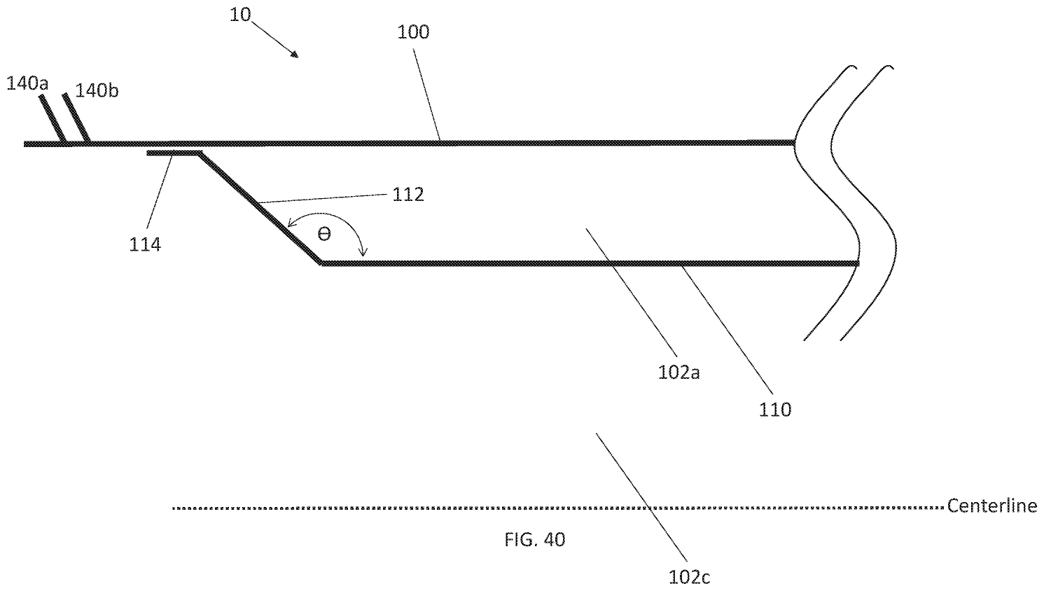

FIG. 39 provides a component similar to FIG. 38, except that projection portion 112 extends from wall 110 at an angle θ greater than 90 degrees, measured from the horizontal. Angle θ can be from 90.01 to about 179 degrees, e.g., from about 91 to about 179 degrees, from about 95 to about 175 degrees, from about 100 to about 170 degrees, from about 105 to about 165 degrees, from about 110 to about 160 degrees, from about 115 to about 155 degrees, from about 120 to about 150 degrees, from about 125 to about 145 degrees, or even from about 130 to about 135 degrees. As shown in FIG. 40, one or more fins can be disposed at an end of the component, e.g., at an end of wall 100. Fins can be disposed such that they do not overlie land 114, as shown in FIG. 40.

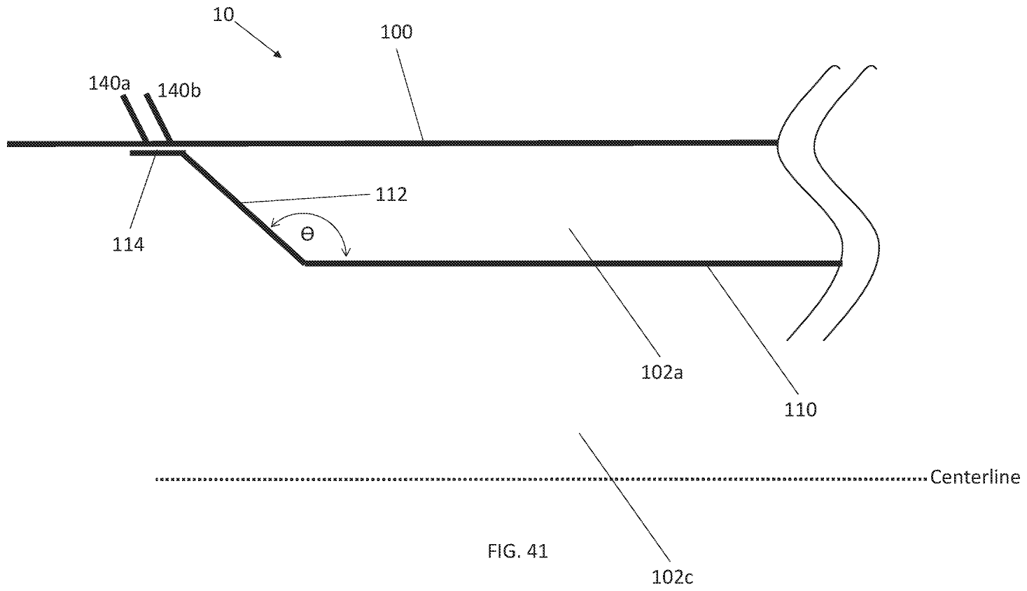

FIG. 41 provides a component similar to FIG. 38, except that fins 140a and 140b are located on wall 100 at a distance from the end of wall 100. In the embodiment shown in FIG. 41, the fins overlie land 114. This configuration allows for the heat sink to be in close proximity to the braze joint. This allows the heat sink to interact with the portion of the assembly that is typically thicker than the remainder of the assembly. In this manner the heat sink helps to drain the thermal dam created by the joint of the material.

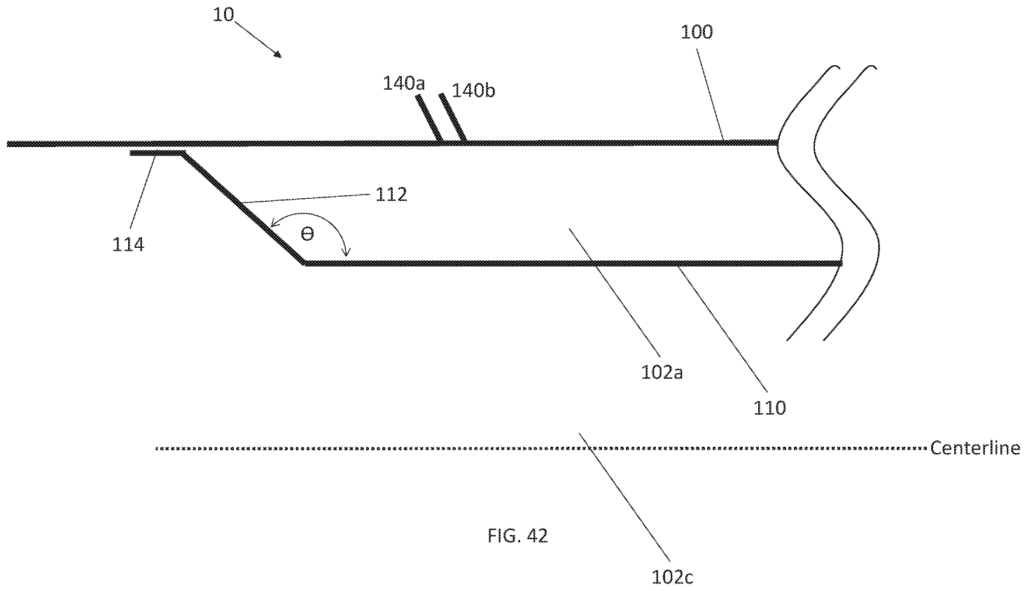

FIG. 42 provides a component similar to FIG. 41, except that fins 140a and 140b are located on wall 100 at a distance from the end of wall 100, and do not overlie land 114. In this configuration, fins can help control the overall temperature of the wall with which they are engaged. A heat sink placed away from the end joint connecting the inner section and the outer section of the vacuum space has the benefit of allowing the outward facing section of the device to heat or cool along the length while mitigating the temperature impact at or close to the fin configuration. This configuration can be desirable where conservation of energy is required in the application; however, a reduced skin temperature is also desirable. Numerous sets of fins can be configured on the wall of the apparatus to control the thermal energy between the sets of fins. This configuration may be particularly useful in applications where mounting devices need to be isolated, where sensitive equipment may be located nearby, to control and/or route the thermal energy in a consumer application, or in other applications.

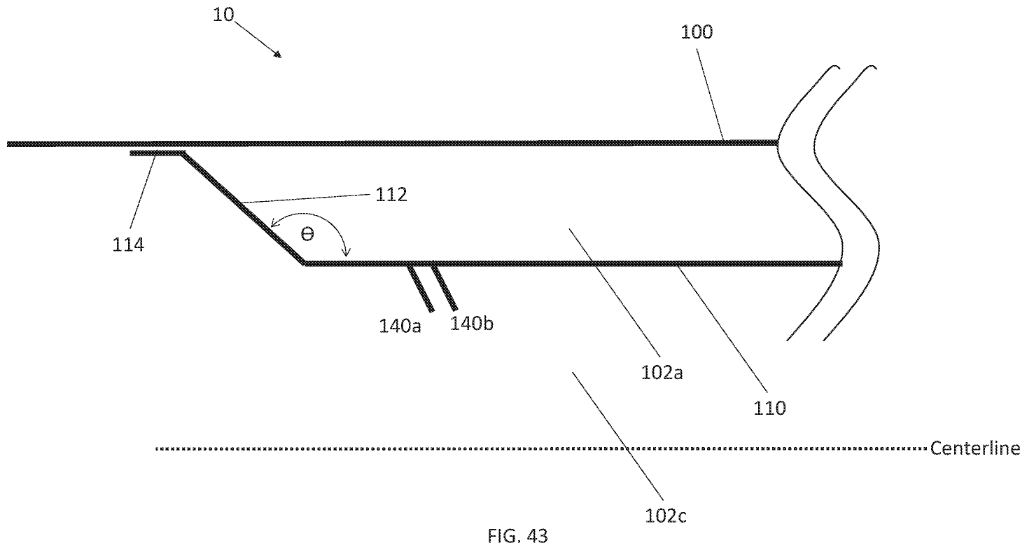

FIG. 43 provides a component similar to FIG. 42, except that fins 140a and 140b are located on wall 110, and do not overlie land 114. This benefit of this implementation is similar to FIG. 42 only the thermal energy is controlled on the inner lumen of the device. This may be needed to protect sensitive electronics, isolate equipment, or similar.

All of these aforementioned fin configurations can be used individually or combined in a single device. The number and configurations of the fins can be selected based on application and the thermal requirements of the user.

FIG. 44 provides a cutaway view of a joint-containing component according to the present disclosure. As shown, the component can include wall 100, sloped portion 4402 connected with wall 100, and land 4402; the component can also include wall 100, sloped portion 4406, and land 4404. A sealed joint can be formed, e.g., by sealing material (such as braze material) 4450, which join in turn effects sealed space/volume 102a formed between walls 100, 110, 4400, and 4410. (Space/volume 102a can be evacuated.) As shown, walls 110 and 4410 can enclose space 102c.

The component can be configured such that one or both of land 4402 and 4402 spring back against wall 4400 and/or wall 4410, as shown by spring back directions A1 and A2. Spring back is not a rule or requirement, but it can be used to maintain the relative positions of the walls and/or help to secure walls to one another. Without being bound to any particular theory or configuration, lands 4402 and 4404 can diverge outward (e.g., in the manner of a trumpet) when not inserted into the space between walls 4400 and 4410. In this way, two segments of a component can be joined to one another while also maintaining the seal (and reduced pressure) of space/volume 102a.

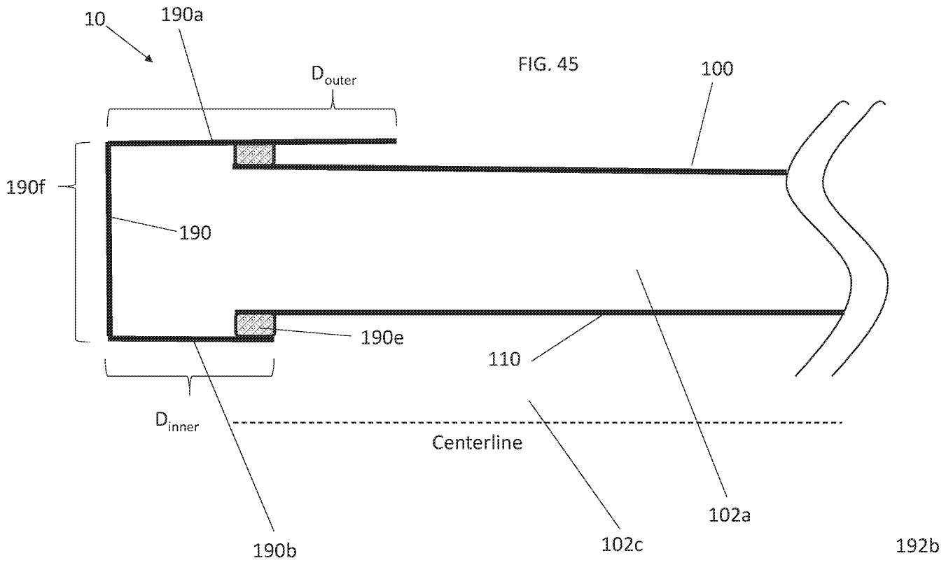

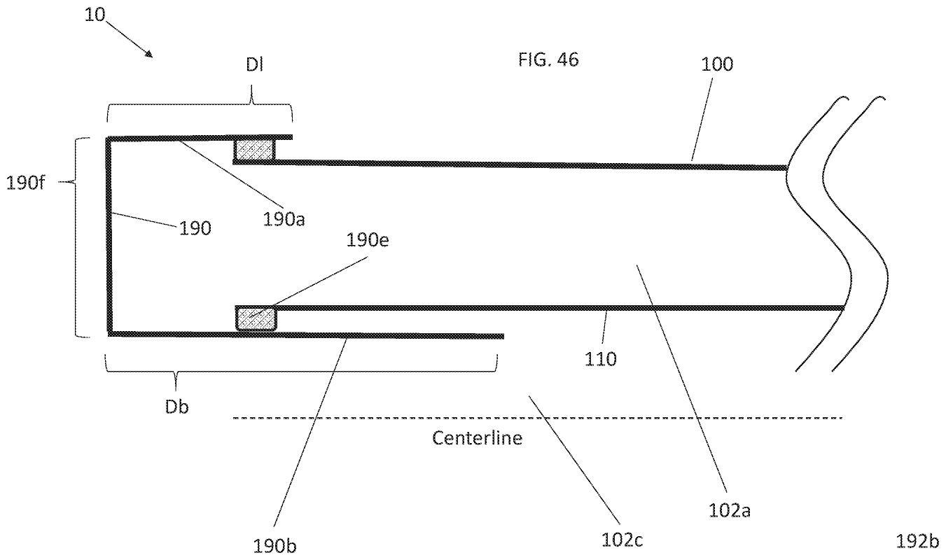

FIGS. 45 and 46 provide alternative embodiments of the component shown in FIG. 37. As shown in FIG. 45, distance Dl can be greater than distance Db. As shown in FIG. 46, distance Db can be greater than distance Dl.

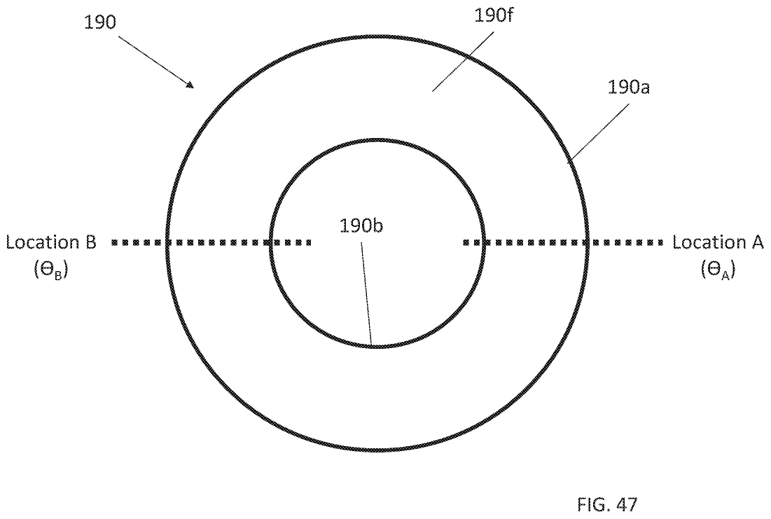

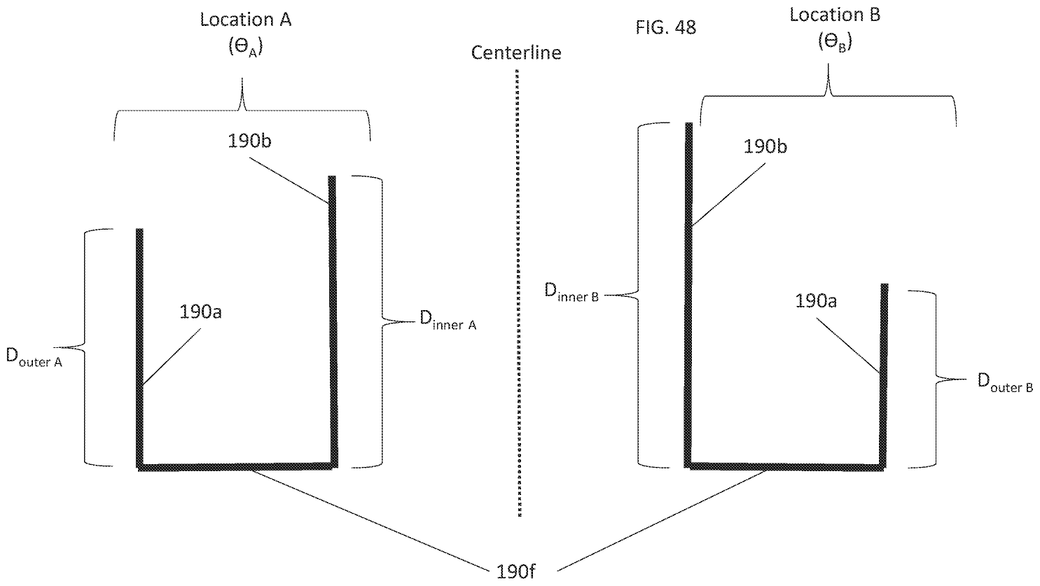

FIG. 47 provides an end-on view of a cap 190 according to the present disclosure. (An exemplary such cap is shown in FIG. 45.) As shown, cap 190 includes land 190a (which can also be considered the outer wall of w cap), end 190f, and land 190b (which can also be considered the inner wall of the cap). The end 190f can serve to connect land 190a and land 190b. FIG. 47 also defines two locations (i.e., Location A and location B) that are disposed at different angles (θA and θB) around the circumference of the cap. As shown in FIG. 48, the inner and outer walls of the cap can be of different heights at different locations around the circumference of the cap.

FIG. 48 provides a cross-sectional view of the cap shown in FIG. 47. As shown, the heights of the lands of a cap can differ around the circumference of the cap. For example, at location A (θA), the outer wall/land 190a defines a height D_{outer A}. At location B (θB), the outer wall/land 190a defines a height D_{outer B}, which can be the same as, greater than, or less than D_{outer A}. Likewise, at location A (θA), the inner wall/land 190b defines a height D_{inner A}. At location B (θB), the inner wall/land 190b defines a height D_{inner B}, which can be the same as, greater than, or less than D_{inner A}. In this way, a cap can provide a region around its circumference that extends further along an inner wall to which the cap is fitted. A cap can also provide a region around its circumference that extends further along an outer wall to which the cap is fitted.

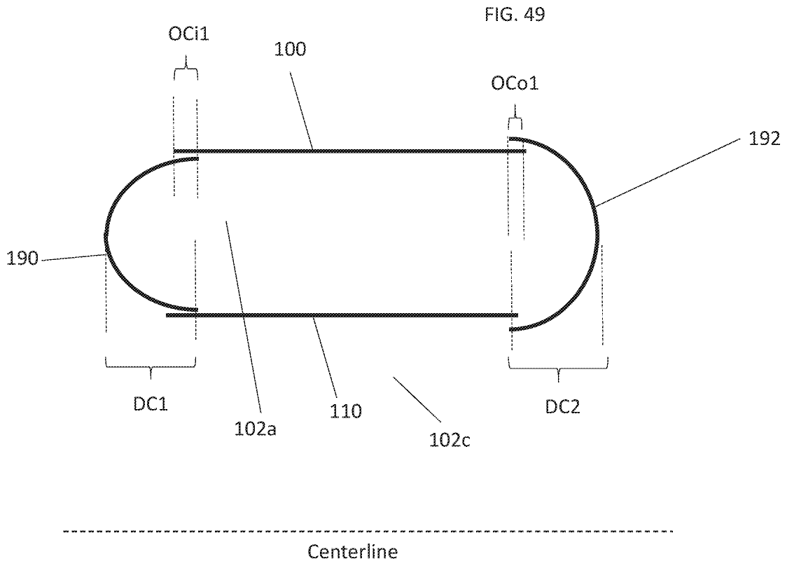

FIG. 49 provides a cutaway view of an exemplary article according to the present disclosure. As shown, an article can include first wall 100 and second wall 110. First cap 190 can be sealed to first wall 100 and second wall 110; exemplary sealing processes include brazing, welding, and the like. As shown, first cap 190 can be curved or cup-shaped in configuration. First cap 190 can be fitted such that it is sealed to facing surfaces of first wall 100 and second wall 110. As shown, the first cup can define a height DC. As shown by the article of FIG. 49, first cap 190 can define an overlap length OCi, which is the length of the overlap between first cap 190 and first wall 100. The ratio of DC to OCi1 can be, e.g., from about 200:1 to about 1:200, or from about 100:1 to about 1:100, or from 50:1 to about 1:50, or from 10:1 to about 1:10, or from about 5:1 to about 1:5.

Likewise, first cap 190 can define an overlap length OCi2 (not labeled) between itself and second wall 110. The ratio of DC to OCi2 can be, e.g., from about 200:1 to about 1:200, or from about 100:1 to about 1:100, or from 50:1 to about 1:50, or from 10:1 to about 1:10, or from about 5:1 to about 1:5.

Second cap 192 can be sealed to first wall 100 and second wall 110; exemplary sealing processes include brazing, welding, and the like. As shown, second cap 192 can be curved or cup-shaped in configuration. Second cap 192 can be fitted such that it is sealed to non-facing surfaces of first wall 100 and second wall 110. As shown, second first cup can define a height DC2. As shown by the article of FIG. 49, second cap 192 can define an overlap length OCo1, which is the length of the overlap between second cap 192 and first wall 100. The ratio of DC2 to OCo1 can be, e.g., from about 200:1 to about 1:200, or from about 100:1 to about 1:100, or from 50:1 to about 1:50, or from 10:1 to about 1:10, or from about 5:1 to about 1:5.

Likewise, second cap 192 can define an overlap length OCi2 (not labeled) between itself and second wall 110. The ratio of DC2 to OCi2 can be, e.g., from about 200:1 to about 1:200, or from about 100:1 to about 1:100, or from 50:1 to about 1:50, or from 10:1 to about 1:10, or from about 5:1 to about 1:5. As shown in FIG. 49, sealed space 102a can be defined by first cap 190, second cap 192, first wall 100, and second wall 110. A lumen or other space 102c can be defined by second wall 110; the lumen can define a centerline (as shown).

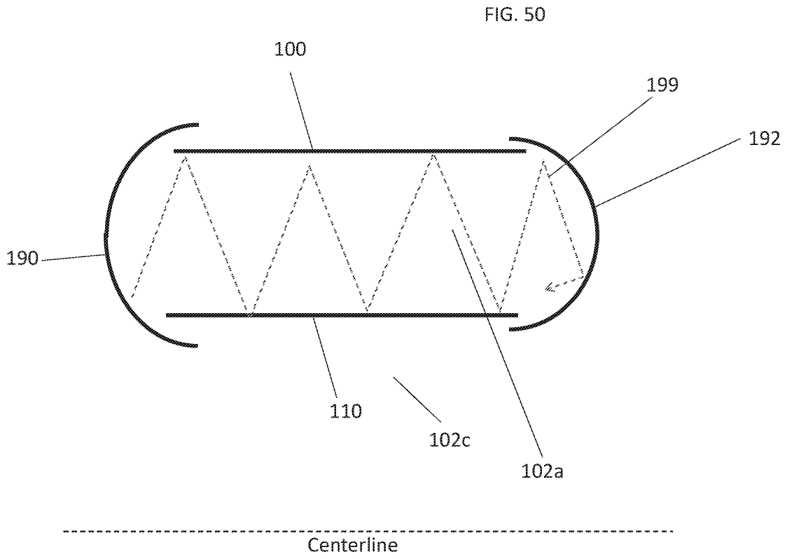

FIG. 50 provides a cutaway view of an exemplary component according to the present disclosure, showing both first cap 190 and second cap 192 being sealed to non-facing surfaces of first wall 100 and second wall 110. As shown by path 199, a molecule disposed within space 102a can deflect against any or all of first cap 190, second cap 192, first wall 100, and second wall 110, when the molecule undergoes excitation, e.g., thermal excitation.

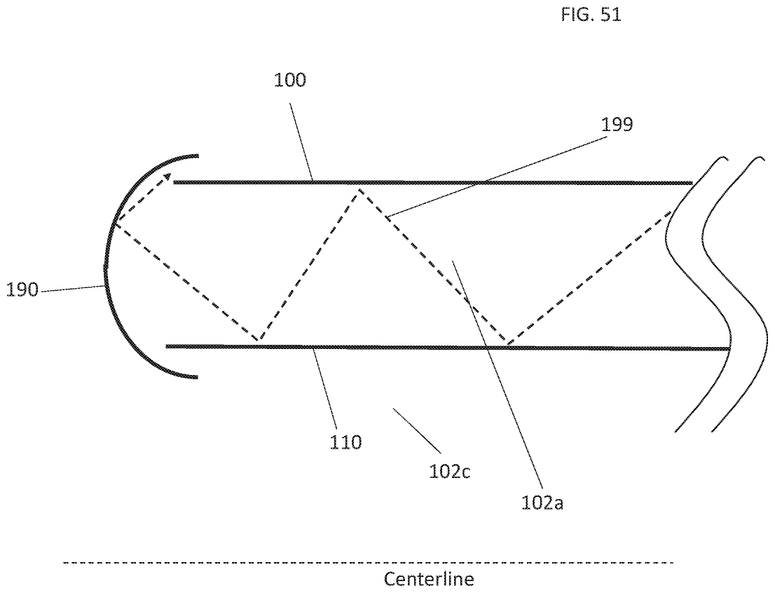

FIG. 51 provides a cutaway view of a component according to the present disclosure. As illustrated by pathway 199 (and without being bound to any particular theory), first element 190 can act as a hangar or other element.

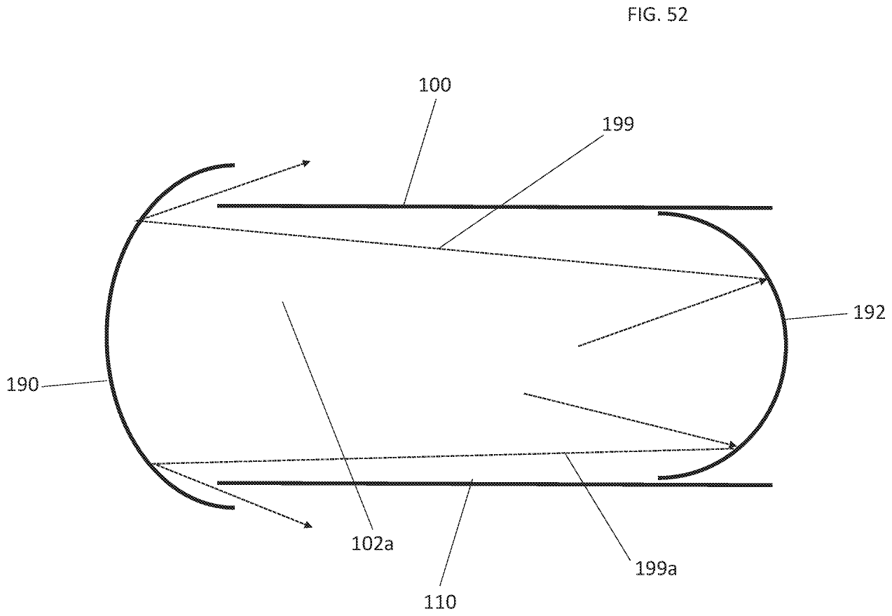

FIG. 52 provides a cutaway view of an exemplary component according to the present disclosure. As shown, a molecule following pathway 199 deflects off of concave second cap 192. Following that deflection, the molecule is naturally directed towards the periphery of space 102a defined between first wall 100 and second wall 110. Following along path 199, the deflected molecule the deflects (again) against concave first cap 190 and then out of space 102a through the gap (not labeled) between first cap 190 and first wall 100. Similarly, a molecule following pathway 199a deflects off of second cap 192. Following along path 199a, that molecule then deflects off of first cap 190 and then out of space 102a through the gap (not labeled) between first cap 190 and first wall 100.

Testing Systems

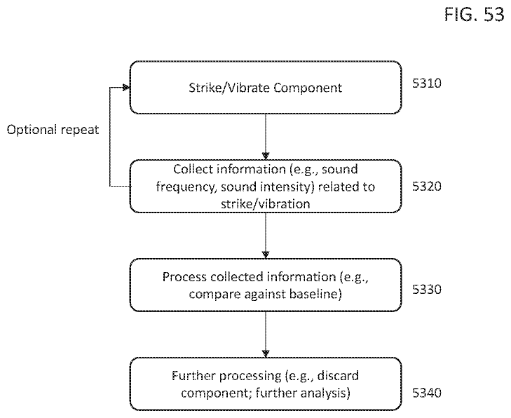

FIG. 53 provides an illustrative embodiment of the disclosed technology. As shown in FIG. 53, one may strike and/or vibrate a component at stage 5310. Example striking and vibration techniques are known to those of ordinary skill in the art.

At stage 5320, one may collect information (e.g., sound frequency, sound intensity, sound duration) that is related to the strike/vibration. It should be understood that one may repeat any of stage 5310 and stage 5320 any number of times. One may also perform multiple strikes/vibrations of a component, and collect information from each such act.

At stage 5330, one may process the collected information. This can take the form of, e.g., determining an intensity of the sound, determining the frequency of the sound, determining the duration of the sound, determining a statistic (average, band/interval, and the like) of the collected information. Processing can also take the form of comparing collected information (or of comparing processed such information) against other information, e.g., a baseline frequency. Processing can also take the form of determining whether collected information (or processed such information) falls within a certain range, e.g., a desired “bandwidth” of frequencies or a desired “bandwidth” of sound durations.

At stage 5340, one may perform further processing of a component based on foregoing stages. As one example, one may discard a component that has a frequency (in response to a strike) that falls outside of a certain “baseline” range that is characteristic of a component having a desired characteristic. As another example, one may advance a component that has a frequency (in response to a strike) that is within a certain “baseline” range to a further stage (e.g., packaging, sale) of a process.

Processing

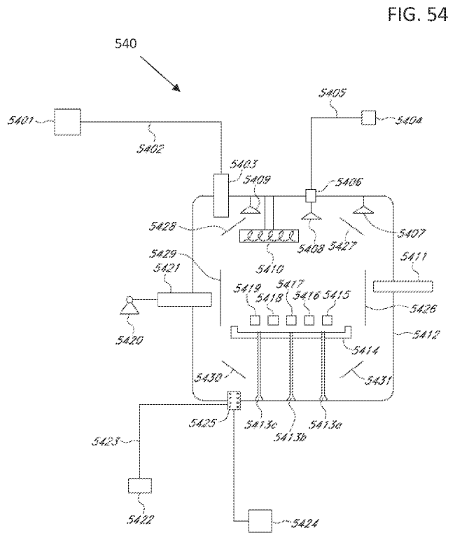

FIG. 54 provides an illustrative view of system 540 according to the present disclosure. A system can include an enclosure 5412. An enclosure can be sealable, e.g., by a vault door or other door or hatch. An enclosure can have one, two, or more doors, which multiple doors can facilitate insertion and removal of products from the enclosure. In some embodiments, the enclosure can be characterized as a furnace.

A system can include reservoir 5401, which can be a fluid reservoir. A fluid can be a liquid, gas, or at the point of transition between liquid and gas. The fluid can be heated, chilled, or at ambient temperature. The fluid can transition from a liquid phase to a gas. The fluid can also be pressurized (above atmospheric pressure), but can also be at atmospheric or even reduced pressure. Reservoir 5401 can be connected via line 5402 to inlet 5403, which inlet can place reservoir 5401 into fluid communication with the interior of enclosure 5412. A valve or other flow control device can be used to modulate fluid flow from reservoir 5401 into enclosure 5412. The valve can also be used to restrict the fluid from flowing from the enclosure 5412 to the container 5401. A controller (not shown) can be used to monitor and/or modulate fluid flow through inlet 5403.

In some embodiment, one or more fluid distributors (shown by 5407, 5408, and 5409) can be used to distribute fluid into the interior of enclosure 5412. Reservoir 5401 can be in fluid communication with one or more of the fluid distributors, and one or more manifolds can be used to distribute fluid among the one or more fluid distributors. Inlet 5406 can be in communication with controller 5404, and can also be in fluid communication with one or more fluid distributors. A fluid distributor can be, e.g., a manifold, a sprayerhead, or other dispersing structure. A system according to the present disclosure can have multiple fluid distributors in fluid communication with a single fluid source (e.g., reservoir 5401), but can also have multiple fluid distributors in fluid communication with multiple fluid sources. Likewise, a single fluid distributor can be in fluid communication with a single fluid source, but can also be in fluid communication with multiple fluid sources.

A system can also include one or more outlets 5425. An outlet can be in communication with a controller 5422, e.g., via communication line 5423. An outlet can also be in fluid communication with a tank or drain 5424, e.g., via an outlet line. An outlet can comprise a valve or other modality configured to modulate fluid flow through the outlet. As one example, an outlet can be configured to remain closed until a certain time of heating has elapsed in enclosure 5412; an outlet can also be configured to remain closed until a certain weight of fluid on the floor of the interior of the enclosure is detected.

System 540 can also include one more heating elements 5410. A heating element can be positioned at any location within the interior of enclosure 5412. For example, a heating element can be positioned nearby to or even against the top, bottom, or side of the enclosure. In some embodiments, a heating element is positioned at a location intermediate within the interior of the enclosure, e.g., midway between interior walls of the enclosure, or at a distance from any wall of the interior of the enclosure. A system can also include one or more element (shown by 5427, 5426, 5431, 5430, 5429, and 5428), which can act as hangars. Elements can be arranged symmetrically, although this is not a requirement.

A system can include one more pumps 5420, e.g., one or more vacuum pumps. The pump is in in fluid communication with the interior of enclosure 5412, e.g., by way of port 5421.

A system can also include one or more monitoring devices 5411; a monitoring device can be configured to monitor one or more of temperature, pressure, humidity, the presence of a molecular species (e.g., the level of a gas), and the like. Example monitoring devices include, e.g., a thermocouple, a pressure monitor, a humidity monitor, and the like. A monitoring device can be in electronic communication with a controller or other device that modulates a condition (e.g., temperature, pressure) within the interior of the enclosure.

A system can also include one or more racks (5414) that are utilized to support workpieces (5415, 5416, 5417, 5418, and 5419) that are processed by the system. A rack can be supported by one or more legs or other supports (5413a, 5413b, and 5413c).

A workpiece can be of any size and shape. Workpieces can be, e.g., cylindrical, polyhedral, spherical, conic, frustoconical, ovoid, or other shapes. The size of a workpiece can depend on the needs of the user and on the dimensions of the enclosure where the workpiece is processed. Workpieces can be, e.g., concentric tubes being joined to one another so as to form an evacuated insulating space therebetween. Workpieces need not be concentric tubes, however, and can comprise non-tubular boundaries (e.g., concave plates, and the like).

A system according to the present disclosure can be configured to maintain a workpiece in a single location and/or position. A system can also be configured (e.g., via motorized rollers) to move a workpiece during the workpiece's processing by the system. As an example, a system can be configured to rotate workpieces while the workpieces are processed (e.g., via exposure to heat, vacuum, or other conditions) within the interior of enclosure 5412. A system can include one or more modalities for introducing and/or removing workpieces from the interior of enclosure 5412. Introduction of workpieces can be done in a manual fashion, but can also be done in an automated fashion. Conveyors, boats, belts, moveable baskets, and the like can all be used to introduce workpieces into an enclosure and also to remove workpieces from an enclosure. Workpieces can be introduced into an enclosure in a batch approach, but can also be introduce in a semi-batch or even a continuous approach.

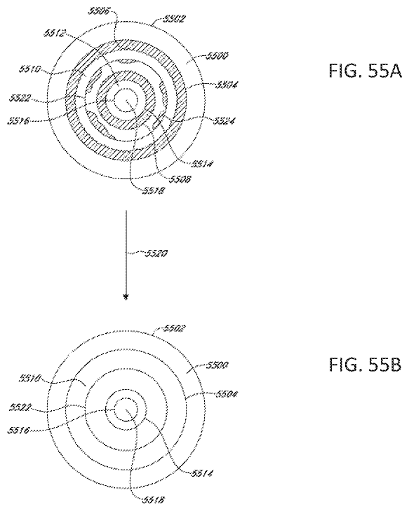

FIG. 55A provides a cutaway view of an illustrative workpiece before the workpiece has been processed according to the present disclosure. (The illustrative workpiece of FIG. 55A is formed from concentric inner and outer walls, having a spacer material disposed between the inner and outer walls.) As shown, a workpiece can include outer wall 5500, which outer wall has an outer surface 5502 and inner surface 5504. Impurities 206 are shown on the inner surface 5504 of outer wall 200.

Also shown are impurities 5508 on the outer surface 5514 of inner tube 5512. (Inner tube also defines inner surface 5516, and a lumen 5518 therein.) Also shown is spacer material 5522 disposed in space 5510 between the inner surface 5504 of outer tube 5500 and the outer surface 5514 of inner tube 5512. Impurities 5524 are present on the surface of spacer material 5522.

Following processing 5520, impurities 5506, 5508, and 5524 are at least partially removed from the workpiece. Exemplary processing steps are described elsewhere herein, and can include one or more of heating, cooling, reduced pressure, fluid application, increased pressure, chemical treatment, and the like. As one example, application of a low pressure can be performed to draw a first fluid into one or more of the spaces between the inner and outer walls and the spacer material and one or both of the inner and outer walls. A different pressure and/or temperature can then be applied to remove the fluid from that space, with the fluid acting (e.g., via motion and/or reaction with the impurities) to at least partially remove impurities that the fluid contacts. One can use heat to assist in the removal of impurities.

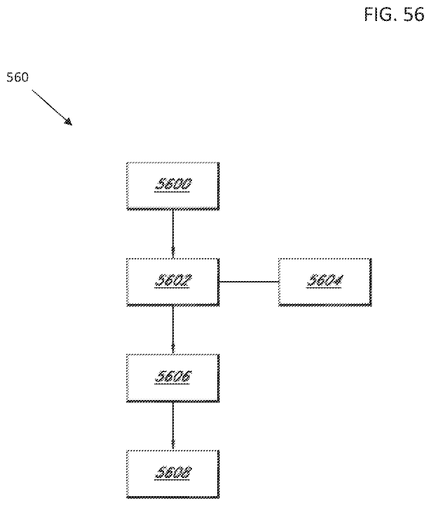

FIG. 56 provides a flowchart-type overview of an exemplary process 560 according to the present disclosure. As shown, one or more workpieces can undergo first step 5600. First step 5600 can include, e.g., introducing the workpieces into the enclosure. As shown, workpieces can undergo second step 5602. Second step 5602 can be modulated by assessment 5604. As one example, the second step can be application of heat, which heat can be modulated by a thermocouple, controller, processor, or other modality that controls the intensity and/or duration of heat application. A workpiece can also undergo third step 5606 and can also undergo fourth step 5606. Third step 5606 can differ from second step 5602 in one or more ways. As one example, third step can be application of 500 deg. C. heat for 10 minutes, while second step 5602 can be application of 350 deg. C. heat for 300 minutes. One or more of steps 5600, 5602, 5606, and/or 5608 can include one or more of heating, refrigeration, application of reduced pressure, application of increased pressure, application of fluid, withdrawal of fluid, and the like. It can also include a relative cooling by converting the fluid to steam and then removing the resulting gas. It should be understood that any processing steps can be performed in a repeating manner, e.g., a cycle of heat followed by the introduction of a fluid followed by another cycle of heat.

### EMBODIMENTS

The following non-limiting embodiments are illustrative only and do not serve the limit the scope of the present disclosure or the appended claims.

Embodiment 1. A molecule excitation chamber, comprising: a first wall bounding an interior volume, the first wall comprising a main portion having a length and a projection portion having a length, the main portion optionally extending perpendicular to the projection portion; a second wall bounding the interior volume, the second wall comprising a main portion having a length and optionally comprising a projection portion having a length, (a) the projection portion of the first wall and the second wall defining a first vent therebetween, or (b) the second wall and the first wall defining a second vent therebetween, or (c) both (a) and (b), and the ratio of the length of the main portion of the first wall to the projection portion of the first wall being from about 1000:1 to about 1; 1, and, optionally, a heat source configured to effect heating of molecules disposed within the interior volume of the molecule excitation chamber.

Embodiment 2. The molecule excitation chamber of Embodiment 1, wherein the second wall is configured to deflect molecules that collide with the second wall toward the first vent. This deflection can be accomplished by, e.g., the wall being angled and/or curved. The first wall can also be configured to deflect molecules that collide with the first wall toward the second vent.

Embodiment 3. The molecule excitation chamber of any one of Embodiments 1-2, wherein the molecule excitation chamber comprises a second vent.

Embodiment 4. The molecule excitation chamber of Embodiment 3, wherein the second vent is defined by the first wall and the projection portion of the second wall.

Embodiment 5. The molecule excitation chamber of any one of Embodiments 3-4, wherein the second vent is disposed opposite the first vent.

Embodiment 6. The molecule excitation chamber of Embodiment 5, wherein the space defines a major axis and wherein, a line drawn parallel to the major axis does not intersect both the first vent and the second vent.

Embodiment 7. The molecule excitation chamber of any one of Embodiments 1-6, wherein the space is sealed and further wherein the space is evacuated to a pressure of from about 0.0001 to about 700 Torr, e.g., from about 0.001 to about 70 Torr, from about 0.01 to about 7 Torr, or even about 1 Torr.

Embodiment 8. The molecule excitation chamber of Embodiment 7, wherein the space is evacuated to a pressure of from about 0.005 to about 5 Torr.

Embodiment 9. A method, comprising opening the first vent of a molecule excitation chamber according to any of Embodiments 1-8. The opening can be effected by, e.g, heating so as to effect thermal expansion of a wall or other component that defines the vent.

Embodiment 10. A method, comprising: assembling (a) a first wall comprising a main portion having a length and a projection portion having a length, the main portion optionally extending perpendicular to the projection portion, and the ratio of the length of the main portion of the first wall to the projection portion of the first wall being from about 1000:1 to about 1; 1, and (b) a second wall comprising a main portion having a length and optionally comprising a projection portion having a length, the assembling being performed so as to define a first vent defined by the projection portion of the first wall and the second wall, and, sealing the first vent so as to seal a space between the first wall and the second wall.

Embodiment 11. The method of Embodiment 10, wherein the sealing is accomplished with a sealing material. Suitable sealing materials include, e.g., brazing materials, welding materials, and the like. The sealing can be effected under heating, and the heating can be applied such that one or both walls undergo thermal expansion so as to open a space into which brazing material can flow. The walls, brazing material, and heating can be accomplished such that under the heating, a space between the walls is formed, and then the brazing material flows into the space so as to fill the space. Heating can also be modulated to as to close the space between the walls.

Embodiment 12. The method of Embodiment 11, wherein the sealing material acts to at least partially occlude the first vent during sealing.

Embodiment 13. The method of Embodiment 12, wherein the sealing material forms a meniscus during sealing.

Embodiment 14. The method of Embodiment 10, wherein the first wall and the second wall define a second vent therebetween.

Embodiment 15. The method of Embodiment 14, wherein the second vent is defined by the first wall and a projection portion of the second wall.

Embodiment 16. The method of any of Embodiments 14-15, wherein the space defines a major axis and wherein, a line drawn parallel to the major axis does not intersect both the first vent and the second vent. A non-limiting example of this is provided in FIG. 1, in which a line parallel to line 150 does not intersect both vent 116 and vent 118.

Embodiment 17. The method of any of Embodiments 10-16, further comprising applying heat under conditions sufficient so as to give rise to a pressure within the space of from about 0.0001 to about 50 Torr.

Embodiment 18. The method of Embodiment 17, wherein the heat is applied so as to give rise to a pressure within the space of from about 0.005 to about 5 Torr.

Embodiment 19. An insulating component, comprising: a first wall bounding an interior volume; a second wall spaced at a distance from the first wall so as to define an insulating space between the first wall and the second wall; an inner surface of the second wall facing the insulating space, and an outer surface of the first wall facing the insulating space, (a) the first wall comprising an extension portion that (i) extends from a first end of the first wall toward the inner surface of the second wall and is optionally essentially perpendicular to the inner surface of the second wall and/or (ii) extends toward a second end of the first wall, the extension portion of the first wall optionally further comprising a land portion that is essentially parallel to the inner surface of the second wall, or (b) the second wall comprising an extension portion that (i) extends from a first end of the second wall toward the outer surface of the first wall and is optionally essentially perpendicular to the outer surface of the first wall and/or (ii) extends toward a second end of the second wall, the extension portion of the second wall optionally further comprising a land portion that is essentially parallel to the outer surface of the first wall, or both (a) and (b), and a first vent communicating with the insulating space to provide an exit pathway for gas molecules from the insulating space, the vent being sealable for sealing the insulating space following egress of gas molecules through the vent.

Embodiment 20. The insulating component of Embodiment 19, wherein the first and second walls are characterized, respectively, as a first tube and a second tube. It should be understood that in any embodiment herein, one or both walls can be tubular in configuration.

Embodiment 21. The insulating component of Embodiment 20, wherein the first and second tubes are arranged coaxial with one another.

Embodiment 22. The insulating component of any one of Embodiments 19-21, wherein the extension portion of the first wall defines a length LE1, as measured by a line perpendicular to the first wall.

Embodiment 23. The insulating component of Embodiment 22, wherein the first wall defines a length WL1, and wherein the ratio of LE1 to WL1 is from about 1:1000 to about 1:2.

Embodiment 24. The insulating component of Embodiment 23, wherein the ratio of LE1 to WL1 is from about 1:10 to about 1:5.

Embodiment 25. The insulating component of any one of Embodiments 19-24, wherein the extension portion of the second wall defines a length LE2, as measured by a line perpendicular to the second wall.

Embodiment 26. The insulating component of Embodiment 25, wherein the second wall defines a length WL2, and wherein the ratio of LE2 to WL2 is from about 1:1000 to about 1:2.

Embodiment 27. The insulating component of Embodiment 26, wherein the ratio of LE2 to WL2 is from about 1:100 to about 1:5.

Embodiment 28. The insulating component of any of Embodiments 19-27, wherein the second wall is configured such that effective conditions effect thermal expansion of the second wall relative to the first wall such that the first vent is opened.

Embodiment 29. The insulating component of any one of Embodiments 19-28, wherein the first vent is at least partially defined by the land portion of the first wall.

Embodiment 30. The insulating component of Embodiment 29, further comprising a second vent, the second vent being at least partially defined by the land portion of the second wall.

Embodiment 31. The insulating component of Embodiment 30, wherein, along a line extending parallel to the inner surface of the second wall, the first vent and the second vent do not overlap one another.

Embodiment 32. The insulating component of any one of Embodiments 19-31, further comprising a sealant that seals the first vent so as to seal the insulating space, the sealant optionally being disposed so as to at least partially occlude the first vent. Sealants can be, e.g., braze materials. An insulating component can include one or more heat exchange features; e.g., fins that extend from one or both of the first wall and the second wall.

Embodiment 33. A method, comprising communicating a fluid within the interior volume of an insulating component according to any one of Embodiments 19-32.

Embodiment 34. A method, comprising heating a material disposed at least partially within the interior volume of an insulating component according to any one of Embodiments 19-32. As described elsewhere herein, materials can be heated within any component according to the present disclosure. As described elsewhere herein, materials can be heated within any component according to the present disclosure.

Embodiment 35. The method of Embodiment 34, wherein the heating comprising heating the material without burning the material. As described elsewhere herein, materials can be heated within any component according to the present disclosure.

Embodiment 36. The method of any one of Embodiments 34-36, wherein the material comprises a smokeable material, e.g., a plant-based material.

Embodiment 37. A method, comprising: with a first wall bounding an interior volume and a second wall spaced at a distance from the first wall, a volume defined between the first wall and the second wall, (a) the first wall comprising an extension portion that extends toward the second wall and is optionally essentially perpendicular to the inner surface of the second wall, the extension portion of the first wall optionally further comprising a land portion that is essentially parallel to the inner surface of the second wall, (b) the second wall comprising an extension portion that extends toward the outer surface of the first wall and is optionally essentially perpendicular to the outer surface of the first wall, the extension portion of the second wall optionally further comprising a land portion that is essentially parallel to the outer surface of the first wall, or both (a) and (b), and (c) the land portion of the first wall contacting the second wall so as to define a volume between the first wall and the second wall, (d) the land portion of the second wall contacting the first wall so as to define a volume between the first wall and the second wall, or both (c) and (d), heating the first wall and the second wall under conditions effective to effect thermal expansion of the second wall relative to the first wall, the thermal expansion giving give rise to or increasing a space between the land portion of the first wall and the second wall and/or giving rise to or increasing a space between the land portion of the second wall and the first wall, thereby allowing gas molecules to exit the volume defined between the first wall and the second wall.

Embodiment 38. The method of Embodiment 37, wherein the heating is performed at less than atmospheric pressure.

Embodiment 39. The method of any one of Embodiments 37-38, wherein the thermal expansion gives rise to or increases a space between the land portion of the first wall and the second wall.

Embodiment 40. The method of any one of Embodiments 37-39, wherein the thermal expansion gives rise to or increases a space between the land portion of the second wall and the first wall.

Embodiment 41. The method of any one of Embodiments 37-40, wherein the thermal expansion gives rise to or increases a space between the land portion of the first wall and the second wall and gives rise to or increases a space between the land portion of the second wall and the first wall.

Embodiment 42. The method of any one of Embodiments 37-41, wherein the heating is effective to effect sealing by a sealant of the space between the land portion of the first wall and the second wall and/or the space between the land portion of the second wall and the first wall.

Embodiment 43. An insulating component, comprising: a first wall bounding an interior volume; a second wall spaced at a distance from the first wall so as to define an insulating space between the first wall and the second wall; a first cap, the first cap at least partially sealing the insulating space defined between the first wall and the second wall, the first cap comprising a first land, the first land optionally sealed to the first wall, and the first cap further comprising a second land, the second land optionally sealed to the second wall. a first vent communicating with the insulating space to provide an exit pathway for gas molecules from the insulating space, the first vent being sealable for sealing the insulating space following egress of gas molecules through the vent.

Embodiment 44. The insulating component of Embodiment 43, wherein the first vent is defined by the first land and the first wall. The first vent can, in some embodiments, be defined between the second land and the second wall.

As described elsewhere herein, a cap can be sealed to the walls by way of, e.g., brazing, welding, adhesive, sonic welding, and the like. Sealing material (e.g., a ribbon of braze material) can be disposed at a distance from an end of the cap (see, e.g., FIG. 37 attached hereto and related description). Without being bound to any particular theory, the longer the distance (along the wall, in a direction away from the cap) from the end of cap to the sealing material, the less heat transfer between the interior volume and the environment exterior to the insulating component. Again without being bound by any particular theory, the reduction in heat transfer can be a result of the comparatively long heat path presented by a component in which the distance from the end of the cap to the sealing material is comparatively long.

Embodiment 45. The insulating component of any one of Embodiments 43-44, further comprising a second cap, the second cap at least partially sealing the insulating space defined between the first wall and the second wall.

Embodiment 46. The insulating component of Embodiment 45, wherein the second cap comprises a first land and a second land.

Embodiment 47. The insulating component of Embodiment 45, wherein the first land and the second land of the second cap extend in generally the same direction.

Embodiment 48. The insulating component of Embodiment 45, wherein the first land and the second land of the second cap extend in generally opposite directions.

Embodiment 49. The insulating component of any one of Embodiments 43-48, wherein the first land and the second land of the first cap extend in generally the same direction.

Embodiment 50. The insulating component of any one of Embodiments 43-48, wherein the first land and the second land of the first cap extend in generally opposite directions. An insulating component can include one or more heat exchange features; e.g., fins that extend from one or both of the first wall and the second wall.

Embodiment 51. The insulating component of any one of Embodiments 43-50, wherein (a) the first land of the first cap defines a height that varies around a perimeter of the cap, (b) the second land of the first cap defines a height that varies around a perimeter of the cap, or (a) and (b). Without being bound to any particular theory or embodiment, FIGS. 47-48 are illustrative of Embodiment 51.

Embodiment 52: A method, comprising: with an insulating component according to any one of Embodiments 43-51, communicating a fluid within the interior volume.

Embodiment 53: A method, comprising: with an insulating component according to any one of Embodiments 43-51, sealing the first land of the first cap to the first wall.

Embodiment 54: An insulating component, comprising: a first wall; a second wall, the first wall enclosing the second wall, the first wall comprising a sloped portion that extends toward the second wall (e.g., by converging or diverging) and the first wall also comprising a land portion that extends from the sloped portion, the second wall comprising a sloped portion that extends (e.g., by converging or diverging) toward the first wall, and the second wall also comprising a land portion that extends from the sloped portion, a third wall; a fourth wall, the third wall enclosing the fourth wall, the land of the first wall being sealed to the third wall and the land of the second wall being sealed to the fourth wall so as to at least partially seal a space between the first wall and the second wall that is in fluid communication with a space between the third wall and the fourth wall.

An example is provided by FIG. 44, described elsewhere herein. Also as described elsewhere herein (e.g., in FIG. 44), the land of the first wall and/or the land of the second wall can be formed so as to effect spring back against one or both of the third wall and the fourth wall.

It should be understood that any component disclosed herein can be used as a molecular excitation chamber. As one example, a heating source can be used to excite molecules within the component (i.e., molecules located in the space between the walls of the component). Upon application of the heating, at least some of the molecules will, by virtue of their motion, exit the space by way of a vent disposed between the walls of the component.

By virtue of collisions between the molecules themselves and/or the walls (or other features of the space between the walls), the moving molecules will, statistically, have a probability of existing the space by way of a vent. The egress of at least some of the molecules from the space in turn acts to lower the pressure within the space, and the user can then—by sealing the space following molecular egress—give rise to a permanently evacuated space. A user can place a so-called getter material into the space between the walls, but a getter is not a requirement, and the disclosed components can operate without the presence of a getter, i.e., they can be getter-free.

The disclosed components can be used in a variety of applications, including, without limitation: medical equipment, consumer products, instrumentation (e.g., spectroscopy equipment), firearms, exhaust systems, fluid handling, combustion devices, freezing devices, cryogenics, batteries (energy storage), automotive, aerospace, consumer goods, and many others. The disclosed components can be used in, e.g., vaping or e-cigarette devices, including those that operate using solid and/or liquid consumables. A material can be heated within a component; the heating can be performed to heat the material by burning, but the material can also be heated in a heat-not-burn fashion. Smokeable materials can be heated within components according to the present disclosure. Solids, liquids, and even gases can be disposed within a component according to the present disclosure.

Embodiment 55: An insulating component, comprising: a first wall bounding an interior volume; a second wall spaced at a distance from the first wall so as to define an insulating space between the first wall and the second wall; a first cap defining a curved profile, the first cap at least partially sealing the insulating space defined between the first wall and the second wall, a second cap defining a curved profile, the second cap comprising a first portion sealed to the first wall, the second cap further comprising a second portion sealed to the second wall, and the curved profile of first wall and the curved profile of the second wall being concave away from one another.

Embodiment 56. The insulating component of Embodiment 53, wherein the first cap is sealed to facing surfaces of the first wall and the second wall.

Embodiment 57. The insulating component of Embodiment 53, wherein the first cap is sealed to non-facing surfaces of the first wall and the second wall.

Embodiment 58. The insulating component of Embodiment 53, wherein the second cap is sealed to facing surfaces of the first wall and the second wall.

Embodiment 59. The insulating component of Embodiment 53, wherein the second cap is sealed to non-facing surfaces of the first wall and the second wall.

Testing Methods

Embodiment 60. A testing method, comprising: subjecting a component to a strike, a vibration, or both, the component comprising a sealed evacuated region within the component; processing one or more items of information related to the subjecting; and correlating the one or more items of information to a physical characteristic of the component.

A component can be, e.g., an insulating tube, an insulating plate, an insulating sphere, and the like. The disclosed methods can be applied to components of virtually any shape or size.

A strike can be effected by, e.g., hitting the component. As but one example, a component can be struck by a felt-covered hammer. A strike can also be effected by way of the component falling a distance (which distance can be, e.g., a few millimeters or even a meter) onto a surface. The surface can be hard (e.g., stainless steel), but can also include a cushioning layer, e.g., a layer of rubberization.

Vibration can be performed by contacting the component with a vibration device, e.g., an oscillating head that is in mechanical communication with a motor. Suitable such motors include, e.g., eccentric rotating mass (ERM) motors and linear resonant actuator (LRA) motors. The component can also be in mechanical communication with a vibration device. As one example, a rigid rod or arm can be used to transmit vibrations from the vibration device to the component.

Processing information can be accomplished by, e.g., processing information (e.g., a sound) collected by a microphone or other transducer. The processing can comprise, e.g., comparing the information or a feature of the information to a baseline information or a feature of that baseline information, comparing the information or a feature of the information to one or more other items of information (or features of those one or more items of information) received from testing other components, including the information in a population of items of information (e.g., including the information or a feature of the information as part of a statistical calculation), saving the information or a feature of the information to a fixed or transitory medium, and the like.

As one non-limiting example, a user can strike a test component and record a sound evolved from that strike. The user can then compare one or more features of that sounds (e.g., frequency, intensity) against a model sound and determine whether the sound evolved by the test component is sufficiently similar to the sound evolved by a component that complies with certain specifications.

For example, a user can confirm that 50 components comply with certain manufacturing specifications. The user can then test each of these 50 components by subjecting each component to vibration, according to the present disclosure, collecting a sound from each component test. These 50 sounds can be processed (e.g., averaged) to generate a baseline sound result (which can be a composite of the sounds of the 50 components) against which baseline the sounds from future test components can be compared when those test components are tested according to the present disclosure. If the sound from a future tested component is sufficiently similar to the baseline sound result, the future tested correspondent can be considered to be in compliance with the manufacturing specification in question and advanced to a later step in a manufacturing process. If the sound from the future tested component is not sufficiently similar to the baseline sound result, the future tested component can be diverted from the manufacturing process for further evaluation. Any or all of the foregoing steps can be accomplished in an automated fashion. Testing can also be performed on components of different ages or on a component at different times. For example, one can test a component according to the present disclosure when the component is manufactured to establish a baseline. The component can then be tested (e.g., via striking) at various other times (e.g., 6 months, 1 year, 2 years, and so on) to determine whether the sound evolved from striking the component changes over time or remains the same. If the sound changes by more than a certain amount over time, the component can be further evaluated.

Embodiment 61. The testing method of Embodiment 60, wherein the strike is effected in an automated fashion. This can be accomplished by, e.g., having a striker contact a component as the component departs a stage of a manufacturing line. This can also be accomplished by having the component fall a set distance onto a striker plate.

Embodiment 62. The testing method of Embodiment 60, wherein the strike is effected manually. This can be accomplished by striking (e.g., tapping) a component with a rubberized hammer. This can also be accomplished by, e.g., dropping the component onto a surface.

Embodiment 63. The testing method of Embodiment 60, wherein the strike is effected by dropping the component onto a substrate, the substrate optionally being a striker plate.

Embodiment 64. The testing method of Embodiment 60, wherein the vibration is effected by a vibrator device in mechanical communication with the component.

Embodiment 65. The testing method of Embodiment 60, wherein the vibration is effected by a vibrator device in fluid communication with the component.

Embodiment 66. The testing method of any of Embodiments 60-65, wherein the one or more processed are from a first surface of the component and wherein the subjecting is effected on a second surface of the component. As one example, a tubular component can be struck on the outer surface of the tube, and the sound from the strike can be recorded by a transducer placed on the inner surface of the tube. In some embodiments, the striking and/or vibrating is effected on a surface of the component that is disposed across the sealed enclosed region from a transducer. In this way, one can assess the vibration that crosses the sealed evacuated region.

A component can comprise one or more materials. A component can comprise a metal, a ceramic, a cermet, or any combination thereof. Stainless steel is considered especially suitable, but there is no requirement that a component include stainless steel.

Embodiment 67. The testing method of any of Embodiments 60-66, further comprising securing the component at a first surface of the component and wherein the subjecting is effected on a second surface of the component. In one embodiment, the component is secured by, e.g., a suction cup or other attachment on the outer surface of the component, and a transducer is located at an inner surface of the component.

Embodiment 68. The testing method of any of Embodiments 60-67, further comprising maintaining the component in an orientation during the subjecting of the component to the strike, vibration, or both. This can be done by, e.g., holding the component in a jig that maintains the component's orientation. The method can be practiced such that each component that is tested is held in the same orientation. Each component that is tested can be struck/vibrated on the same location on the component, and a detector (e.g., a transducer) can be

Embodiment 69. The testing method of any of Embodiments 60-68, further comprising maintaining the component in at least partial vibrational isolation from environmental vibrations. This can be accomplished by placing the component on an isolation table (e.g., a surface that is disposed atop a fluid, springs, or other dampers). In some embodiments, a user can place the component into contact with a damper, e.g., a putty or other dampening material.

Embodiment 70. The testing method of any of Embodiments 60-69, wherein the physical characteristic comprises a thermal insulation characteristic of the component. The disclosed methods can be used to estimate, e.g., the presence and/or extent of a physical feature of the component. For example, the sound evolved from exposing a component with a uniform-thickness insulating region to vibration can differ from the sound evolved from exposing a component with a variable-thickness insulating region. The physical characteristic can be, e.g., a moisture content, a porosity, or a thickness.

Embodiment 71. The testing method of any of Embodiments 60-70, wherein the sealed evacuated region within the component is characterized as annular in configuration. The sealed evacuated region can be planar, and can be a flat plane or a curved plane. The sealed evacuated region can also be cylindrical in shape. The sealed evacuated region can have a constant cross-section along an axis, but can also have a variable cross-section along an axis.

Embodiment 72. The testing method of any of Embodiments 60-71, wherein the component comprises an amount of one or more ceramics.

Embodiment 73. A testing system, comprising: a vibrator device; a component mount; and a component secured to the component mount, the component comprising an amount of ceramic, the component comprising a sealed evacuated region within the component, or both, the component being secured such that the component is in mechanical communication with the vibrator device, fluid communication with the vibrator device, or both.

Embodiment 74. The testing system of Embodiment 73, further comprising a transducer disposed at a surface of the component. A microphone is an example of a suitable transducer.

Embodiment 75. The testing system of Embodiment 74, wherein the system is configured such that the transducer is disposed at a surface of the component that differs from a surface of the component that receives vibration from the vibrator device.

Embodiment 76. The testing system of any of Embodiments 73-75, wherein the system is configured to receive one or more items of information evolved from the component related to subjecting the component to energy from the vibration device and optionally wherein the system is configured to and correlate the one or more items of information to a physical characteristic of the component.

Embodiment 77. A testing system, comprising: a strike plate; and a transducer configured to receive energy evolved from the impact of a component onto the strike plate.

Embodiment 78. The testing system of Embodiment 77, wherein the transducer is configured to receive energy evolved from the component upon impact of the component onto the strike plate.

A system according to the present disclosure can include a processor configured to isolate one or more features (e.g., frequency, intensity, duration) of a sound evolved from subjecting a component to a vibration and/or strike. A processor may also compare the one or more features to one or more corresponding baseline features.

Embodiment 79. The testing system of any of Embodiments 77-78, wherein the system is configured to receive one or more items of information related to impact of the component onto the strike plate and optionally wherein the system is configured to and correlate the one or more items of information to a physical characteristic of the component.

Embodiment 80. A testing system, comprising: a vibrator device; a component mount; and a processor. The processor can be configured to analyze information evolved from application of vibration to a component. The analysis can comprise, e.g., comparing one or more features of the item of information to one or more baseline features.

As another example, a test component may be subjected to a vibration and/or a strike. The subjection of the vibration and/or strike will evolve a sound (not necessarily audible to a human) from the test component. The sound may then be processed. One or more features of the sound (e.g., frequency, intensity, duration) can then be compared (e.g., by the processor) against one or more baseline features that is/are indicative of a desired component. The processor may be configured to alert the user if the designated feature or features of the test component are within a certain range (e.g., +/−10%) or outside of a certain range (e.g., +/−10%) relative to the baseline features. A user may elect to, e.g., discard components that do not exhibit features that are within a certain range of a baseline feature.

### PROCESSING EMBODIMENTS

Embodiment 81. A method of preparing an insulating component, comprising: forming a conditioned region of a surface of a first boundary component by conditioning at least a portion of the surface of the first boundary component; forming a conditioned region of a surface of a second boundary component by conditioning at least a portion of the surface of the second boundary component; and processing the first boundary component and the second boundary component under conditions sufficient to give rise to a sealed evacuated region between the first boundary component and the second boundary component, the sealed evacuated region being at least partially defined by the conditioned region of the surface of the first boundary component and the conditioned region of the surface of the second boundary component.

Forming a conditioned region can be accomplished by, e.g., washing, drying, scrubbing (chemical or mechanical), and the like. Drying can be effected by, e.g., fluid flow, heating, mechanical drying, chemical drying, and the like. Drying can also be effected by dehumidification. Forming a conditioned region can be accomplished by flow of a fluid. Forming a conditioned region can be accomplished by heated fluid flow, cooled fluid flow, or alternating fluid flows. Forming a conditioned region can also be accomplished by introduction of a fluid at a first temperature and pressure, and then changing one or both of the temperature and pressure. As an example, one can introduce a fluid to the first boundary component and then change the temperature so as to freeze the fluid onto the first boundary component.

Forming a conditioned region can be further accomplished by changing the fluid (e.g., replacing one fluid with another) that contacts the boundary components.

Forming the conditioned region can be accomplished under pressure (e.g., greater than 1 atm), or under reduced pressure (e.g., less than 1 atm). Forming the conditioned region can be accomplished in a vacuum chamber or even in a vacuum furnace. The conditioning can be performed in a dehumidified environment. The conditioning can be performed to, e.g., reduce or even eliminate moisture present on the first and/or second boundary components. Conditioning can be performed to remove oils or other residues or species that can be present in or on the first boundary and second boundary. Forming a conditioned region can be performed in a sealed chamber, e.g., a vacuum chamber or furnace. Alternatively, forming a conditioned region can be accomplished by

A boundary (i.e., the first and/or second boundary) can be tubular in configuration. As one example, the first and second boundaries can be concentric tubes, with a space therebetween, which space can then be sealed form the sealed evacuated region. The first and second boundaries can also be, e.g., cans such that the cans are disposed such that there is a space defined between the circumferential wall of the inner can and the circumferential wall of the outer can.

In some embodiments, changing pressure within the chamber in which boundaries are disposed can act as a sort of pump. Without being bound to any particular theory, the pressure in a processing chamber can be reduced so as to draw air out from a space between two concentric tubes. This can be accomplished by, e.g., a temperature change that differentially expands one of the concentric tubes. A user can also introduce a second fluid into the chamber, and can change the pressure and/or temperature within the chamber so as to effect disposal of the second fluid into the space between the concentric tubes. As an example, there can be air disposed in a sealed space between concentric inner and outer tubes. By increasing the temperature in a vacuum chamber, the outer tube can expand. Following that removal, a user can introduce fluid into the chamber, thereby acting to dispose the fluid into the space between the tubes.

A conditioned region can be circular in shape, but this is not a requirement. A conditioned region can be polygonal in shape, e.g., a square or rectangle. A conditioned region can represent from about 1 to 100% of a surface of a boundary component. As one example, a conditioned region could be the entire outer surface of a tubular boundary component. In some embodiments, the entirety of the sealed evacuated region is defined entirely by conditioned regions of the boundary components, though this is not a requirement. A boundary component can include one, two, or more conditioned regions. As one example, only a portion (e.g., 25% to 75% of the length) of a boundary component can be a conditioned region, e.g., a central conditioned region flanked by un-conditioned regions on either side.

It should be understood also that a boundary component can include regions that are differently conditioned. As one example, a boundary region can include a first region conditioned via exposure to a given first temperature and a first fluid and a second region conditioned via exposure to a second fluid at a second temperature. The conditioning of different regions can be effected by, e.g., masking a second region of the boundary component while conditioning a first region of the component followed by unmasking that region and applying a second processing. (Following the unmasking of the second region, the first conditioned region can optionally be masked.)

The first boundary and second boundary can be connected to one another to form the sealed evacuated region by, e.g., a connection boundary, which connection boundary can be straight, curved, undulating, corrugated, or otherwise nonlinear. The connection boundary can be a region of the first or second boundary. The connection boundary can also be a separate component, e.g., a ring that bridges the first and second boundary components. As one non-limiting example, inner and outer concentric tubes can be connected to one another at their ends by tapered regions of one or both of the inner and outer concentric tubes. Some non-limiting examples are provided in the various patent applications cited herein.

Processing the first boundary component and the second boundary component to form the sealed evacuated region can be accomplished by, e.g., brazing, welding, adhering, and the like. This can give rise to a vacuum-insulated vent and structure; non-limiting, exemplary vacuum-insulated vents and structures (and related techniques for forming and using such structures) can be found in United States patent application publications 2017/0253416, 2017/0225276, 2017/0120362, 2017/0062774, 2017/0043938, 2016/0084425, 2015/0260332, 2015/0110548, 2014/0090737, 2012/0090817, 2011/0264084, 2008/0121642, and 2005/0211711, all by A. Reid, and all incorporated herein by reference in their entireties for any and all purposes. It should be understood that a vacuum (i.e., any vacuum within the disclosed devices and methods) can be effected by the methods in the aforementioned applications or by any other method known in the art.

It should also be understood that one can perform conditioning (as described elsewhere herein) on braze material or on other joining material. This can be performed when the braze or other joining material is applied but before the braze or other material is used to join the desired surfaces or after the braze or other joining material has been used to join the desired surfaces. As an example, one can apply braze material to an inner tube, effect brazing between the inner tube and an outer tube via the braze material, and then condition the applied braze material. Suitable conditioning is described elsewhere herein and can include, e.g., heating in an environment of a first fluid, followed by removal of that first gas (and any impurities that can reside in that first fluid) and, optionally, replacement of that first fluid with a second fluid.

Conditioning can be performed so as to form a material on a surface of a boundary. For example, conditioning can be performed so as to grow an oxide on a surface of a boundary. Conditioning can be performed so as to form one material (e.g., a first oxide) on a surface of the first boundary and then performed so as to form a material (e.g., a second oxide) on a surface of the second boundary.

Conditioning can also mean to place a surface of a boundary into contact with a fluid. As an example, a user can form a conditioned region of a first boundary by placing the boundary into contact with a fluid, e.g., an oil, and then processing the first and second boundaries such that the oil is contained with a sealed space between the first and second boundaries. Conditioning can also include disposing a fluid (e.g., an oil) in the space between the first and second boundaries by reducing the environmental pressure so as to draw the fluid into the space between the first and second boundaries. One can also increase the pressure so as to at least partially expel the fluid from the space between the first and second boundaries. Fluid can also be at least partially removed from the space between the boundaries by heating, by gravity, or even by reduced pressure. A user can utilize pressure, heat, gravity, or any combination (or sequence) of the foregoing to draw and/or remove fluid from a space between the first and second boundaries.

Embodiment 82. The method of Embodiment 81, wherein the conditioning is performed so as to reduce impurities (e.g, moisture) from the conditioned region of the first boundary component, from the conditioned region of the second boundary component, or both. Example impurities include, e.g., lubricants, oxides, volatiles, or other such species.

Embodiment 83. The method of any of Embodiments 81-82, wherein the conditioning comprises drawing a fluid into a space between the first boundary component and the second boundary component. The fluid can be a gas. The fluid can be drawn through the space between the first and second in a pulsatile fashion. The fluid can be drawn through the space in an alternating fashion.

A user can, for example, exert a first fluid into the space and then exert a second fluid into the space. The user can also exert fluid into the space and also exert/remove fluid from the space, e.g., in a reciprocating or in-and-out manner. Fluid can be flowed within the space for from about 1 second to 10 hours, for 30 seconds to 5 hours, for 1 minute to 1 hour, or even for about 5 minutes to 30 minutes.

Embodiment 84. The method of any of Embodiments 81-83, wherein the conditioning heating comprises heating. The heating can be convective, radiative, or by other technique. The heating can be at a temperature above 100 deg. C., e.g., about 120, about 150, about 200, about 250, about 300, about 350, or 400 deg. C. or greater.

In an example process, the temperature and pressure can be held constant or varied during the course of the process. For example, a fluid can be introduced to a chamber that contains the first and second boundaries. The pressure within the chamber can be reduced so as to draw the gas into the space between the first and second boundaries. The temperature and/or pressure can then be varied so as to effect motion of the fluid within the space between the boundaries.

As an example, the first and second boundaries can be heated (e.g., under vacuum) in a chamber, and the gas within the chamber can be replaced, so as to remove impurities that can have evolved or that can have been present on the first and second boundaries. As another example, first and/or second boundaries can be heated in a treatment chamber under a first set of temperature and pressure conditions (e.g., a vacuum) in the presence of a first fluid for a first period of time. Following that period of time, the fluid can be withdrawn from the treatment chamber, and the treatment chamber can be re-filled with “fresh” fluid of choice.

Embodiment 85. The method of any of Embodiments 81-84, further comprising disposing a spacer material between the first boundary component and the second boundary component such that the spacer material remains within the sealed evacuated region. Spacer material can be present as, e.g., a sheet or as a winding. Spacer material can be present as a thread, for example.

Embodiment 86. The method of Embodiment 85, wherein the spacer material comprises a ceramic.

Embodiment 87. The method of Embodiment 85, wherein the spacer material comprises boron nitride.

Embodiment 88. The method of any of Embodiments 85-87, further comprising conditioning at least a portion of the spacer material, heating at least a portion of the spacer material, or both. (Suitable conditioning methods are described elsewhere herein.)

Embodiment 89. The method of any of Embodiments 1-8, wherein one or both of the first boundary component and the second boundary component comprises a ceramic.

Embodiment 90. The method of any of Embodiments 81-89, wherein one or both of the first boundary component and the second boundary component comprises a metal. Example metals include, e.g., stainless steel.

Embodiment 91. The method of any of Embodiments 81-90, wherein the processing comprises brazing.

Embodiment 92. The method of any of Embodiments 81-91, wherein the processing comprises sealing one or both of the first boundary component and the second boundary component to a sealer component.

Embodiment 93. The method of Embodiment 92, wherein the sealer component comprises a ring. A ring can be, e.g., a metal, a ceramic, a cermet, or other suitable material. A ring can itself be a brazing material or other joining material.

Embodiment 94. The method of Embodiment 93, wherein the ring comprises a ceramic.

Embodiment 95. The method of any of Embodiments 81-84, wherein the sealed evacuated space defines a molecule density of from about 0.1 to about 1000 molecules/cm³.

Embodiment 96. An insulating component prepared according to any of Embodiments 81-95. Such a component can be, e.g., tubular in configuration.

Embodiment 97. A method of preparing an insulating component, comprising: conditioning (a) a facing surface of a first boundary component and (b) a facing surface of a second boundary component; and further processing the first boundary component and a second boundary component under conditions sufficient to give rise to a sealed evacuated region between the facing surface of the first boundary component and the facing surface of the second boundary component.

Suitable conditioning and processing techniques are described elsewhere herein. As one example, processing can include using a flowable braze material to join the first boundary component and second boundary component.

Embodiment 98. The method of Embodiment 97, further comprising disposing a spacer material between the first boundary component and the second boundary component such that the spacer material remains within the sealed evacuated region, the method optionally comprising washing, heating, or washing and heating the spacer material.

Embodiment 99. The method of any of Embodiments 97-98, wherein the sealed evacuated space defines a molecule density of from about 1 to about 1000 molecules/cm³.

Embodiment 100. The method of any of Embodiment 97-99, wherein the processing comprises sealing one or both of the first boundary component and the second boundary component to a sealer component.

Embodiment 101. The method of Embodiment 100, wherein the sealer component comprises a ring.

Embodiment 102. The method of Embodiment 101, wherein the ring comprises a ceramic.

Embodiment 103. An insulated component prepared according to any of Embodiments 97-102.

Embodiment 104. A method of constructing an insulating component, comprising: assembling a first boundary component and a second boundary component so as to form a sealed insulating space between a surface region of the first boundary component and a surface region of a second boundary component, the surface region of the first boundary component and the surface region of the second boundary component treated to remove impurities.

Embodiment 105. An insulated component, comprising: a first boundary component and a second boundary component disposed so as to form a sealed insulating space between a surface region of the first boundary component and a surface region of a second boundary component, the surface region of the first boundary component and the surface region of the second boundary component being treated to remove impurities.

Embodiment 106. A system configured to effect a conditioned region on a workpiece, the system comprising: an enclosure configured to sealably enclose one or more workpieces within the interior of the enclosure; (a) a component configured to modulate at least one of (i) fluid flow into the interior of the enclosure, and (ii) fluid flow out of the interior of the enclosure; (b) an element configured to modulate a temperature within the interior of the enclosure; optionally (c) a heat source (optionally comprising an element configured to direct radiation toward a workpiece disposed within the interior of the enclosure); (d) a fluid source capable of fluid communication with the interior of the enclosure, or any combination of (a), (b), (c), and (d).

An enclosure can be characterized as, e.g., a cabinet, a reactor, a case, and the like.

Embodiment 107. The system of Embodiment 106, further comprising one or more components configured to introduce a workpiece to the interior of the enclosure, remove a workpiece from the interior of the enclosure, or both. Such a component can be, e.g., a conveyor, a boat (e.g., a boat mounted on a rotating table or on a belt), a revolving door-type assembly, and the like.

Embodiment 108. The system of any of Embodiment 106-107, further comprising a manifold configured to distribute fluid into the interior of the enclosure. A system can include sprayheads (sometimes termed “showerheads”), apertures, hoses, atomizers, and the like.

Embodiment 109. The system of any of Embodiments 106-108, further comprising a pump configured to (i) effect a reduced pressure within the interior of the enclosure, (ii) effect an increased pressure within the interior of the enclosure, or both (i) and (ii). A system can include a first pump configured to effect a reduced pressure within the interior of the enclosure and a second pump configured to effect an increased pressure in the interior of the enclosure.

Embodiment 110. The system of any of Embodiments 106-109, further comprising a monitoring device configured to monitor one or more of temperature, pressure, humidity, the presence of a molecular species, or any combination thereof. Example monitoring devices include, e.g., thermocouples, pressure transducers, humidity monitors, chemical detectors (e.g., an ultraviolet and/or infrared absorption or reflectance monitor, an electrical monitor), and the like.

Embodiment 111. The system of any of Embodiments 26-30, further comprising a component configured to move a workpiece in mechanical communication with the workpiece. Such a component can be, e.g., a roller, a rotating table, a lift, a claw, and the like.

Embodiment 112. The system of any of Embodiments 106-111, wherein the system is configured to process a plurality of workpieces. This can be accomplished by way of an enclosure having an interior configured to contain a plurality of workpieces. A system can include a rack (e.g., a raised platform, a hanging platform, and the like) configured to support or more workpieces during processing.

Embodiment 113. The system of any of Embodiments 106-112, wherein the system is configured to operate in a batch manner. As one example, a system can be configured to contain one or more workpieces, process said one or more workpieces, and then process a subsequent batch of one or more workpieces.

Embodiment 114. The system of any of Embodiments 106-112, wherein the system is configured to operate in a continuous manner, e.g., to process workpieces that are on a conveyor that carries the workpieces into the interior of the enclosure.

Embodiment 115. The system of any of Embodiments 106-114, wherein the fluid source comprises a liquid and/or a gas. Example liquids include, e.g., oils, acids, bases, hydrocarbons, chelators, electrolytes, and the like.

Embodiment 116. The system of any of Embodiments 106-114, wherein the fluid comprises a gas.

Embodiment 117. The system of Embodiment 116, wherein the gas comprises a hydrocarbon.

Embodiment 118. A system configured to perform a method according to any of Embodiments 80-102 and 104.

The disclosed systems can be configured to condition one or more boundary components of an insulating component, e.g., via application of heat, fluid, and/or increased or reduced pressure. The systems can also be configured to process a first boundary component and a second boundary component under conditions sufficient to give rise to an evacuated region between the first boundary component and the second boundary component, the evacuated region being at least partially defined by the conditioned region of the surface of the first boundary component and the conditioned region of the surface of the second boundary.

Embodiment 119. A method, comprising: (a) changing a temperature and/or pressure so as to at least partially disrupt an interface between a first and a second boundary within which region is contained a first fluid; (b) removing at least some of the first fluid from the region; (c) introducing a second fluid into said region; and (d) containing the second fluid within the region.

As one example (and as described elsewhere herein), one can change the pressure and/or temperature within the enclosure (sometimes termed a chamber) in which boundaries are disposed. Without being bound to any particular theory, the pressure in a processing chamber can be reduced so as to draw air out from a space between two concentric tubes of a workpiece. This can be accomplished by, e.g., a temperature change that differentially expands one of the concentric tubes, thus allowing at least partial removal of a fluid (e.g., air) disposed between the tubes.

A user can also introduce a second fluid (e.g., a hydrocarbon, an acid, a base, an etchant) into the chamber, and can change the pressure and/or temperature within the chamber so as to effect disposal of the second fluid into the space between the concentric tubes.

As an example, there can be air disposed in a space between concentric inner and outer tubes. By increasing the temperature in a vacuum chamber, the outer tube can expand so as to disrupt the interface between the inner and outer tubes, so as to effect the removal of the air molecules from the space between the inner and outer tubes. Following that removal, a user can introduce a fluid into the chamber, thereby acting to dispose the fluid into the space between the tubes.

One can affect the interface by changing the temperature and/or pressure within the chamber, by solidifying or otherwise reconstituting material that previously contributed to the interface. As an example, one can apply conditions so as to at least partially liquefy or soften a braze material between two concentric tubes. One can then remove the air from that space, and replace that air with a second fluid.

The present disclosures also provides systems configured to perform the disclosed methods. A system can comprise a sealed enclosure (e.g., a vacuum chamber), a fluid source, and one or more modules configured to change a temperature and/or pressure within the enclosure.

The foregoing disclosure is exemplary only and does not serve to limit the scope of the claims appended hereto or to limit the scope of any claims appended to a related application.

1. A molecule excitation chamber, comprising:
a first wall bounding an interior volume,
the first wall comprising a main portion having a length and a projection portion having a length,
the main portion extending perpendicular to the projection portion;
a second wall bounding the interior volume so as to define an insulating space between the first wall and the second wall,
the second wall comprising a main portion having a length and optionally comprising a projection portion having a length,
(a) the projection portion of the first wall and the second wall defining a first vent therebetween, or (b) the second wall and the first wall defining a second vent therebetween, or (c) both (a) and (b), and
the ratio of the length of the main portion of the first wall to the projection portion of the first wall being from about 1000:1 to about 1:1, and, optionally,
a heat source configured to effect heating of molecules disposed within the interior volume of the molecule excitation chamber.

2. The molecule excitation chamber of claim 1, wherein the second wall is configured to deflect molecules that collide with the second wall toward the first vent.

3. The molecule excitation chamber of claim 1, wherein the molecule excitation chamber comprises a second vent.

4. The molecule excitation chamber of claim 3, wherein the second vent is defined by the first wall and the projection portion of the second wall.

5. The molecule excitation chamber of claim 3, wherein the second vent is disposed opposite the first vent.

6. The molecule excitation chamber of claim 5, wherein the insulating space defines a major axis and wherein, a line drawn parallel to the major axis does not intersect both the first vent and the second vent.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. An insulating component, comprising:
a first wall bounding an interior volume;
a second wall spaced at a distance from the first wall so as to define an insulating space between the first wall and the second wall;
an inner surface of the second wall facing the insulating space, and an outer surface of the first wall facing the insulating space,
(a) the first wall comprising an extension portion that (i) extends from a first end of the first wall toward the inner surface of the second wall and is essentially perpendicular to the inner surface of the second wall and/or (ii) extends toward a second end of the first wall, the extension portion of the first wall optionally further comprising a land portion that is essentially parallel to the inner surface of the second wall, or
(b) the second wall comprising an extension portion that (i) extends from a first end of the second wall toward the outer surface of the first wall and is essentially perpendicular to the outer surface of the first wall and/or (ii) extends toward a second end of the second wall, the extension portion of the second wall optionally further comprising a land portion that is essentially parallel to the outer surface of the first wall, or
both (a) and (b), and
a first vent communicating with the insulating space to provide an exit pathway for gas molecules from the insulating space,
the vent being sealable for sealing the insulating space following egress of gas molecules through the vent.

20. The insulating component of claim 19, wherein the first and second walls are characterized, respectively, as a first tube and a second tube.

21. The insulating component of claim 20, wherein the first and second tubes are arranged coaxial with one another.

22. The insulating component of claim 19, wherein the extension portion of the first wall defines a length LE1, as measured by a line perpendicular to the first wall.

23. The insulating component of claim 22, wherein the first wall defines a length WL1, and wherein the ratio of LE1 to WL1 is from about 1:1000 to about 1:2.

24. The insulating component of claim 23, wherein the ratio of LE1 to WL1 is from about 1:10 to about 1:5.

25. The insulating component of claim 19, wherein the extension portion of the second wall defines a length LE2, as measured by a line perpendicular to the second wall.

26. The insulating component of claim 25, wherein the second wall defines a length WL2, and wherein the ratio of LE2 to WL2 is from about 1:1000 to about 1:2.

27. The insulating component of claim 26, wherein the ratio of LE2 to WL2 is from about 1:100 to about 1:5.

28. The insulating component of claim 19, wherein the second wall is configured such that effective conditions effect thermal expansion of the second wall relative to the first wall such that the first vent is opened.

29. The insulating component of claim 19, wherein the first vent is at least partially defined by the land portion of the first wall.

30. The insulating component of claim 29, further comprising a second vent, the second vent being at least partially defined by the land portion of the second wall.

31. The insulating component of claim 30, wherein, along a line extending parallel to the inner surface of the second wall, the first vent and the second vent do not overlap one another.

32. The insulating component of claim 19, further comprising a sealant that seals the first vent so as to seal the insulating space, the sealant optionally being disposed so as to at least partially occlude the first vent.

33. (canceled)

34. A method, comprising heating a material disposed at least partially within the interior volume of an insulating component according to claim 19.

35. The method of claim 34, wherein the heating comprising heating the material without burning the material.

36. The method of claim 34, wherein the material comprises a smokeable material.

37. (canceled)

38. (canceled)

39. (canceled)

40. (canceled)

41. (canceled)

42. (canceled)

43. An insulating component, comprising:
a first wall bounding an interior volume;
a second wall spaced at a distance from the first wall so as to define an insulating space between the first wall and the second wall;
a first cap, the first cap at least partially sealing the insulating space defined between the first wall and the second wall,
the first cap comprising a first land, the first land optionally sealed to the first wall, and the first cap further comprising a second land, the second land optionally sealed to the second wall.
a first vent communicating with the insulating space to provide an exit pathway for gas molecules from the insulating space,
the first vent being sealable for sealing the insulating space following egress of gas molecules through the vent.

44. The insulating component of claim 43, wherein the first vent is defined by the first land and the first wall.

45. The insulating component of claim 43, further comprising a second cap, the second cap at least partially sealing the insulating space defined between the first wall and the second wall.

46. The insulating component of claim 45, wherein the second cap comprises a first land and a second land.

47. The insulating component of claim 45, wherein the first land and the second land of the second cap extend in generally the same direction.

48. The insulating component of claim 45, wherein the first land and the second land of the second cap extend in generally opposite directions.

49. The insulating component of claim 43, wherein the first land and the second land of the first cap extend in generally the same direction.

50. The insulating component of claim 43, wherein the first land and the second land of the first cap extend in generally opposite directions.

51. The insulating component of claim 43, wherein (a) the first land of the first cap defines a height that varies around a perimeter of the cap, (b) the second land of the first cap defines a height that varies around a perimeter of the cap, or (a) and (b).

52. (canceled)

53. (canceled)

54. An insulating component, comprising:
a first wall;
a second wall,
the first wall enclosing the second wall,
the first wall comprising a sloped portion that extends toward the second wall and the first wall also comprising a land portion that extends from the sloped portion,
the second wall comprising a sloped portion that extends toward the first wall and the second wall also comprising a land portion that extends from the sloped portion,
a third wall;
a fourth wall, the third wall enclosing the fourth wall,
the land of the first wall being sealed to the third wall and the land of the second wall being sealed to the fourth wall so as to at least partially seal a space between the first wall and the second wall that is in fluid communication with a space between the third wall and the fourth wall.

55. An insulating component, comprising:
a first wall bounding an interior volume;
a second wall spaced at a distance from the first wall so as to define an insulating space between the first wall and the second wall;
a first cap defining a curved profile,
the first cap at least partially sealing the insulating space defined between the first wall and the second wall,
a second cap defining a curved profile,
the second cap comprising a first portion sealed to the first wall,
the second cap further comprising a second portion sealed to the second wall, and
the curved profile of first wall and the curved profile of the second wall being concave away from one another.

56. The insulating component of claim 55, wherein the first cap is sealed to facing surfaces of the first wall and the second wall.

57. The insulating component of claim 55, wherein the first cap is sealed to non-facing surfaces of the first wall and the second wall.

58. The insulating component of claim 55, wherein the second cap is sealed to facing surfaces of the first wall and the second wall.

59. The insulating component of claim 55, wherein the second cap is sealed to non-facing surfaces of the first wall and the second wall.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)
